(19) United States
(12) Patent Application Publication
(10) Pub. No.: US 2025/0048252 A1
(43) Pub. Date: Feb. 6, 2025

(54) METHOD AND APPARATUS FOR NETWORK ENERGY SAVING

(71) Applicant: FG Innovation Company Limited, Tuen Mun (HK)

(72) Inventors: TZU-YUEH TSENG, Taipei (TW); Yung-Lan Tseng, Taipei (TW); Yen-Hua Li, Taipei (TW); Po-Chun Chou, Taipei (TW)

(21) Appl. No.: 18/792,049

(22) Filed: Aug. 1, 2024

Related U.S. Application Data
(60) Provisional application No. 63/530,368, filed on Aug. 2, 2023.

(51) Int. Cl. H04W 52/02; H04B 7/06; H04W 72/231; H04W 76/20

(52) U.S. Cl. CPC H04W 52/0203; H04B 7/06968; H04W 72/231; H04W 76/20

(57) ABSTRACT

A method performed by a User Equipment (UE) for Network Energy Saving (NES) is provided. The method receives, from a Base Station (BS), a Radio Resource Control (RRC) message including a Transmission Configuration Indication (TCI) list. The method stores the TCI list in the UE. The method receives, from the BS, a Downlink Control Information (DCI) format. The method then updates the TCI list stored in the UE based on the DCI format.

### CROSS-REFERENCE TO RELATED APPLICATION(S)

The present application claims the benefit of and priority to U.S. Provisional Patent Application Ser. No. 63/530,368, filed on Aug. 2, 2023, entitled “ENHANCEMENT OF SPATIAL AND POWER DOMAIN ADAPTATION FOR NETWORK ENERGY SAVINGS,” the content of which is hereby incorporated herein fully by reference into the present disclosure for all purposes.

### FIELD

The present disclosure is related to wireless communication and, more specifically, to User Equipment (UE), Base Station (BS), and method for Network Energy Saving (NES) in the wireless communication networks.

### BACKGROUND

Various efforts have been made to improve different aspects of wireless communication for the cellular wireless communication systems, such as the 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to increase, however, there exists a need for further improvements in the next-generation wireless communication systems.

### SUMMARY

The present disclosure is related to a UE, a BS, and a method for NES in wireless communication networks.

In a first aspect of the present application, a method performed by a UE for NES is provided. The method includes receiving, from a Base Station (BS), a Radio Resource Control (RRC) message including a Transmission Configuration Indication (TCI) list; storing the TCI list in the UE; receiving, from the BS, a Downlink Control Information (DCI) format; and updating the TCI list stored in the UE based on the DCI format.

In some implementations of the first aspect, the TCI list includes a first TCI state that includes a first Quasi Co-Location (QCL) field, and the first QCL field indicates a first reference signal and a first QCL type.

In some implementations of the first aspect, the first QCL field further indicates at least one spatial pattern associated with the first reference signal.

In some implementations of the first aspect, the DCI format includes a first index associated with one of the at least one spatial pattern indicated by the first QCL field, and updating the TCI list stored in the UE includes selecting the one of the at least one spatial pattern to be applied on the first reference signal based on the first index.

In some implementations of the first aspect, the first QCL field further indicates at least one candidate reference signal.

In some implementations of the first aspect, the DCI format includes a first index associated with one of the at least one candidate reference signal indicated by the first QCL field, and updating the TCI list stored in the UE includes determining that the first QCL type is associated with the one of the at least one candidate reference signal based on the first index.

In some implementations of the first aspect, the first TCI state further includes a second QCL field, the second QCL field indicates a second reference signal and a second QCL type, and the first QCL type is different from the second QCL type.

In some implementations of the first aspect, the first reference signal includes a Channel State Information-Reference Signal (CSI-RS).

In a second aspect of the present application, a UE for NES is provided. The UE includes at least one processor and at least one non-transitory computer-readable medium that is coupled to the at least one processor and that stores one or more computer-executable instructions. The computer-executable instructions, when executed by the at least one processor, cause the UE to: receive, from a BS, an RRC message including a TCI list; store the TCI list in the UE; receive, from the BS, a DCI format; and update the TCI list stored in the UE based on the DCI format.

In a third aspect of the present application, a BS for NES is provided. The BS includes at least one processor and at least one non-transitory computer-readable medium that is coupled to the at least one processor and that stores one or more computer-executable instructions. The computer-executable instructions, when executed by the at least one processor, cause the BS to: transmit, to a UE, an RRC message including a TCI list, the RRC message enabling the UE to store the TCI list in the UE; and transmit, to the UE, a DCI format, the DCI format enabling the UE to update the TCI list stored in the UE.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a diagram illustrating an example data structure of an information element (IE) CSI-ReportConfig, according to an example implementation of the present disclosure.

FIG. 2 is a diagram illustrating an example data structure of an IE CSI-AperiodicTriggerState, according to an example implementation of the present disclosure.

FIG. 3 is a diagram illustrating a Medium Access Control (MAC) Control Element (CE) for indicating a pattern of the NES adaptation in the TCI framework #1, according to an example implementation of the present disclosure.

FIG. 4 is a diagram illustrating a MAC CE for activating/deactivating a Semi-Persistent (SP) Channel State Information-Reference Signal (CSI-RS)/Channel State Information-Interference Measurement (CSI-IM) resource set, according to an example implementation of the present disclosure.

FIG. 5A is a diagram illustrating a MAC CE for activating/deactivating a SP CSI-RS/CSI-IM resource set and indicating a pattern of the NES adaptation in the TCI framework #1, according to an example implementation of the present disclosure.

FIG. 5B is a diagram illustrating a MAC CE for activating/deactivating a SP CSI-RS/CSI-IM resource set and indicating a pattern of the NES adaptation in the TCI framework #1, according to an example implementation of the present disclosure.

FIG. 6 is a diagram illustrating a MAC CE for indicating a TCI state for a UE-specific Physical Downlink Control Channel (PDCCH), according to an example implementation of the present disclosure.

FIG. 7A is a diagram illustrating a MAC CE for indicating a TCI state for a UE-specific PDCCH and indicating a pattern of the NES adaptation in the TCI framework #1, according to an example implementation of the present disclosure.

FIG. 7B is a diagram illustrating a MAC CE for indicating a TCI state for a UE-specific PDCCH and indicating a pattern of the NES adaptation in the TCI framework #1, according to an example implementation of the present disclosure.

FIG. 8 is a diagram illustrating a MAC CE for activating/deactivating TCI states for a UE-specific Physical Downlink Shared Channel (PDSCH), according to an example implementation of the present disclosure.

FIG. 9 is a diagram illustrating a MAC CE for indicating a pattern of the NES adaptation in the TCI framework #2, according to an example implementation of the present disclosure.

FIG. 10A is a diagram illustrating a MAC CE for activating/deactivating a SP CSI-RS/CSI-IM resource set and indicating a pattern of the NES adaptation in the TCI framework #2, according to an example implementation of the present disclosure.

FIG. 10B is a diagram illustrating a MAC CE for activating/deactivating a SP CSI-RS/CSI-IM resource set and indicating a pattern of the NES adaptation in the TCI framework #2, according to an example implementation of the present disclosure.

FIG. 11A is a diagram illustrating a MAC CE for indicating a TCI state for a UE-specific PDCCH and indicating a pattern of the NES adaptation in the TCI framework #2, according to an example implementation of the present disclosure.

FIG. 11B is a diagram illustrating a MAC CE for indicating a TCI state for a UE-specific PDCCH and indicating a pattern of the NES adaptation in the TCI framework #2, according to an example implementation of the present disclosure.

FIG. 12 is a diagram illustrating a MAC CE for indicating a TCI state after the NES adaptation in the TCI framework #3, according to an example implementation of the present disclosure.

FIG. 13 is a diagram illustrating a table listing the association between a pair of (N₁, N₂) and a layout of CSI antenna port array, according to an example implementation of the present disclosure.

FIG. 14 is a diagram illustrating a MAC CE for indicating a TCI change, according to an example implementation of the present disclosure.

FIG. 15 is a diagram illustrating a DCI format for providing an NES unified TCI indication, according to an example implementation of the present disclosure.

FIG. 16 is a diagram illustrating a unified TCI framework, according to an example implementation of the present disclosure.

FIG. 17 is a diagram illustrating a MAC CE for the unified TCI state activation/deactivation, according to an example implementation of the present disclosure.

FIG. 18 is a diagram illustrating a MAC CE for the TCI state activation/deactivation in the TCI framework #1, according to an example implementation of the present disclosure.

FIG. 19 is a diagram illustrating a MAC CE for the TCI state activation/deactivation in the TCI framework #3, according to an example implementation of the present disclosure.

FIG. 20 is a flowchart illustrating a method/process performed by a UE for NES, according to an example implementation of the present disclosure.

FIG. 21 is a flowchart illustrating a method/process performed by a BS for NES, according to an example implementation of the present disclosure.

FIG. 22 is a block diagram illustrating a node for wireless communication, according to an example implementation of the present disclosure.

### DETAILED DESCRIPTION

Some of the abbreviations used in the present disclosure include:

| Abbreviation | Full name |
|---|---|
| 3GPP | 3^{rd} Generation Partnership Project |
| 5G | 5^{th} Generation |
| 5GC | 5G Core Network |
| A-CSI | Aperiodic CSI |
| ACK | Acknowledgment |
| AS | Access Stratum |
| BS | Base Station |
| BWP | Bandwidth Part |
| C-RNTI | Cell Radio Network Temporary Identifier |
| CA | Carrier Aggregation |
| CC | Component Carrier |
| CG | Configured Grant |
| CN | Core Network |
| CORESET | Control Resource Set |
| CQI | Channel Quality Indicator |
| CRI | CSI-RS Resource Indicator |
| CSI | Channel State Information |
| CSI-IM | Channel State Information Interference Measurement |
| CSI-RS | Channel State Information Reference Signal |
| DC | Dual Connectivity |
| DCI | Downlink Control Information |
| DL | Downlink |
| DMRS | Demodulation Reference Signal |
| DRB | Data Radio Bearer |
| EPC | Evolved Packet Core |
| E-UTRAN | Evolved Universal Terrestrial Radio Access Network |
| FR | Frequency Range |
| ID | Identifier |
| IE | Information Element |
| IM | Interference Measurement |
| L1/L2/L3 | Layer 1/Layer 2/Layer 3 |
| LI | Layer Indicator |
| LSB | Least Significant Bit |
| LTE | Long Term Evolution |
| MAC | Medium Access Control |
| MAC CE | MAC Control Element |
| MCG | Master Cell Group |
| MIB | Master Information Block |
| MIMO | Multiple Input Multiple Output |
| MN | Master Node |
| MR-DC | Multi-Radio Dual Connectivity |
| MSB | Most Significant Bit |
| NAS | Non Access Stratum |
| NDI | New Data Indicator |
| NES | Network Energy Saving |
| NG-RAN | Next Generation Radio Access Network |
| NR | New Radio |
| NW | Network |
| NZP | Non Zero Power |
| OFDM | Orthogonal Frequency Division Multiplexing |
| PBCH | Physical Broadcast Channel |
| PCell | Primary Cell |
| PDCCH | Physical Downlink Control Channel |
| PDSCH | Physical Downlink Shared Channel |
| PHY | Physical (layer) |
| PMI | Precoding Matrix Indicator |
| PRACH | Physical Random Access Channel |
| PRB | Physical Resource Block |
| PSCell | Primary SCG Cell |
| PUCCH | Physical Uplink Control Channel |
| PUSCH | Physical Uplink Shared Channel |
| QCL | Quasi Co-Location |
| R15/R16/R17 | Rel-15/Rel-16/Rel-17 |
| RA | Random Access |
| RAN | Radio Access Network |
| RAR | Random Access Response |
| RAT | Radio Access Technology |
| Rel | Release |
| RE | Resource Element |
| RF | Radio Frequency |
| RI | Rank Indicator |
| RNTI | Radio Network Temporary Identifier |
| RRC | Radio Resource Control |
| RS | Reference Signal |
| RSRP | Reference Signal Received Power |
| Rx | Reception |
| SCell | Secondary Cell |
| SCG | Secondary Cell Group |
| SI | System Information |
| SIB | System Information Block |
| SINR | Singal to Interference plus Noise Ratio |
| SL | Sidelink |
| SN | Secondary Node |
| SP | Semi-Persistent |
| SRS | Sounding Reference Signal |
| SS | Synchronization Signal |
| SSB | Synchronization Signal Block |
| SSBRI | SS/PBCH Block Resource Indicator |
| TA | Tracking Area |
| TB | Transport Block |
| TCI | Transmission Configuration Indication |
| TDRA | Time Domain Resource Assignment |
| TRP | Transmission Reception Point |
| TS | Technical Specification |
| TTI | Transmission Time Interval |
| UE | User Equipment |
| UL | Uplink |
| UL-SCH | Uplink Shared Channel |
| URLLC | Ultra-Reliable and Low-Latency Communication |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and may not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “In some implementations,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS may be operable to provide radio coverage to a specific geographical area using multiple cells forming the RAN. The BS supports the operations of the cells. Each cell is operable to provide services to at least one UE within its radio coverage.

Each cell (may often referred to as a serving cell) may provide services to one or more UEs within the cell's radio coverage, such that each cell schedules the DL and optionally UL resources to at least one UE within its radio coverage for DL and optionally UL packet transmissions. The BS may communicate with one or more UEs in the radio communication system via the of cells.

A cell may allocate sidelink (SL) resources for supporting Proximity Services (ProSe) or Vehicle to Everything (V2X) services. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As discussed above, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically, Low-Density Parity-Check (LDPC) code and Polar Code. The coding scheme adaption may be configured based on channel conditions and/or service applications.

At least DL transmission data, a guard period, and a UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may include either A or B, both A and B, at least one of A and B.

Examples of some selected terms in the present disclosure are provided as follows.

BWP: A subset of the total cell bandwidth of a cell is referred to as a Bandwidth Part (BWP) and a Bandwidth Adaptation (BA) may be achieved by configuring the UE with BWP(s) and instructing the UE which of the configured BWPs is currently the active one. To enable a BA on the PCell, the BS (e.g., a gNB) configures the UE with UL and DL BWP(s). To enable the BA on SCells, when CA is deployed, the BS configures the UE with one or more DL BWPs. It should be noted that there may be no BWP in the UL. For the PCell, the initial BWP is the BWP used for an initial access. For the SCell(s), the initial BWP is the BWP configured for the UE to operate after an SCell activation. The UE may be configured with a first active uplink BWP by a firstActiveUplinkBWP IE. If the first active uplink BWP is configured for an SpCell, the firstActiveUplinkBWP IE field may contain the ID of the UL BWP to be activated upon performing the RRC (re-)configuration. If such a field is absent, the RRC (re-)configuration may not impose a BWP switching. If the first active uplink BWP is configured for an SCell, thefirstActiveUplinkBWP IE field may contain the ID of the uplink bandwidth part to be used upon the MAC-activation of an SCell.

PCell: When CA is configured, the UE may only have one RRC connection with the network. At the RRC connection establishment/re-establishment/handover, a serving cell may provide the NAS mobility information, and at the RRC connection re-establishment/handover, the serving cell may provide the security input. This serving cell may be referred to as the PCell.

PUCCH SCell: When CA is configured, a UE may be configured with a cell other than the PCell on which the PUCCH resource is configured. This cell may be referred to as the PUCCH SCell.

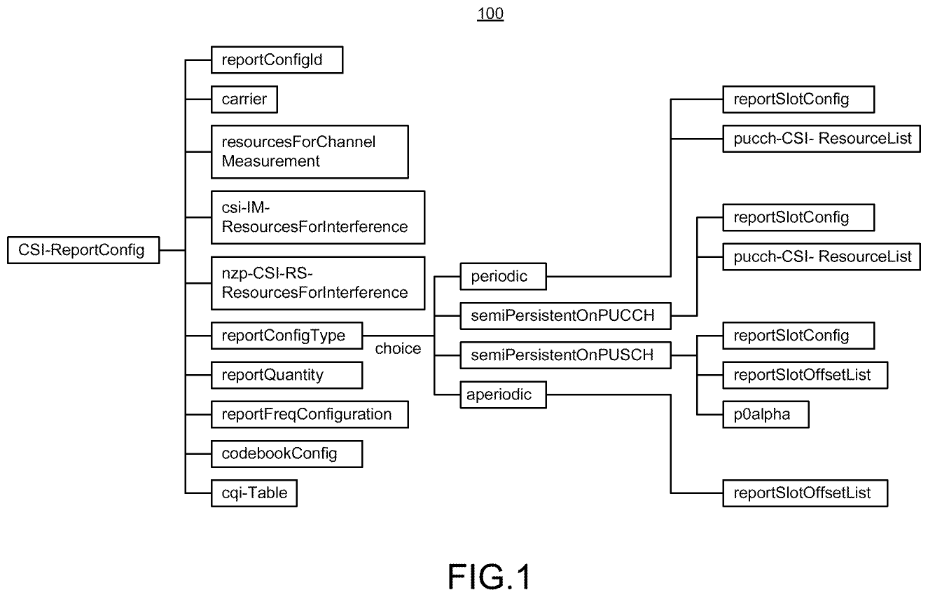

CSI-ReportConfig: A CSI report configuration. FIG. 1 is a diagram 100 illustrating an example data structure of an IE CSI-ReportConfig, according to an example implementation of the present disclosure. It should be noted that the CSI-ReportConfig may include other IEs, which are not listed in FIG. 1 for the sake of brevity and simplicity. The IEs in the CSI-ReportConfig may include:
carrier: This field indicates in which serving cell the CSI-ResourceConfig is to be found. If the field is absent, the resources may be on the same serving cell that provides the CSI report configuration.
codebookConfig: Codebook configuration for Type-1 or Type-2 that includes a codebook subset restriction. If the field codebookConfig-r16 is present, the UE may ignore the codebookConfig field.
cqi-Table: This field indicates which CQI table to be used for the CQI calculation (see, e.g., the 3GPP TS 38.214 V17.5.0, clause 5.2.2.1).
csi-IM-ResourcesForInterference: CSI IM resources for interference measurement. csi-ResourceConfigId of a CSI-ResourceConfig may be included in the configuration of the serving cell indicated with the field “carrier”. The indicated CSI-ResourceConfig may only contain the CSI-IM resources. The bwp-Id in that CSI-ResourceConfig may have the same value as the bwp-Id in the CSI-ResourceConfig indicated by the resourcesForChannelMeasurement.
nzp-CSI-RS-ResourcesForInterference: NZP CSI RS resources for interference measurement. csi-ResourceConfigId of a CSI-ResourceConfig may be included in the configuration of the serving cell indicated with the field “carrier”. The indicated CSI-ResourceConfig may only contain the NZP-CSI-RS resources. The bwp-Id in that CSI-ResourceConfig may have the same value as the bwp-Id in the CSI-ResourceConfig indicated by resourcesForChannelMeasurement.
pucch-CSI-ResourceList: This field indicates which PUCCH resource to be used for reporting on PUCCH.
reportConfigType: This field indicates the time domain behavior of reporting configuration.
reportFreqConfiguration: This field indicates reporting configuration in the frequency domain (see, e.g., the 3GPP TS 38.214 V17.5.0, clause 5.2.1.4).
reportQuantity: The CSI related quantities to report (see, e.g., the 3GPP TS 38.214 V17.5.0, clause 5.2.1). If the field reportQuantity-r16 is present, the UE may ignore the field reportQuantity.
reportSlotConfig: Periodicity and slot offset (see, e.g., the 3GPP TS 38.214 V17.5.0, clause 5.2.1.4). If the field reportSlotConfig-v0530 is present, the UE may ignore the value provided in the field reportSlotConfig.
reportSlotOffsetList, reportSlotOffsetListForDCI-Format0-1, reportSlotOffsetListForDCI-Format0-2: This field may indicate a timing offset Y for semi persistent reporting using the PUSCH. This field may list the allowed offset values. This list may have the same number of entries as the pusch-TimeDomainAllocationList in the PUSCH-Config. A particular value may be indicated in the DCI. The network may indicate, in the DCI field of the UL grant, which of the configured report slot offsets the UE may apply. The DCI field having the value of 0 may correspond to the first report slot offset in the list; the DCI field having the value of 1 may correspond to the second report slot offset in the list, and so on. For example, the UE may be triggered by the lower layer for the CSI reporting in slot n. The first report may be transmitted in slot n+Y, the second report may be transmitted in slot n+Y+P, where Y is the timing offset for the CSI reporting, and P is the configured periodicity. The field reportSlotOffsetList may be for DCI format 0_0, the field reportS/otOffsetListForDCI-Format0-1 may be for DCI format 0_1, and the field reportSlotOffsetListForDCI-Format0-2 may be for DCI format 0_2, respectively (see, e.g., the 3GPP TS 38.214 V17.5.0, clause 6.1.2.1).
resourcesForChannelMeasurement: Resources for channel measurement. csi-ResourceConfigId of a CSI-ResourceConfig may be included in the configuration of the serving cell indicated by the field “carrier”. The indicated CSI-ResourceConfig may only contain the NZP-CSI-RS resources and/or SSB resources. This CSI-ReportConfig may be associated with the DL BWP indicated by the bwp-Id in the CSI-ResourceConfig.

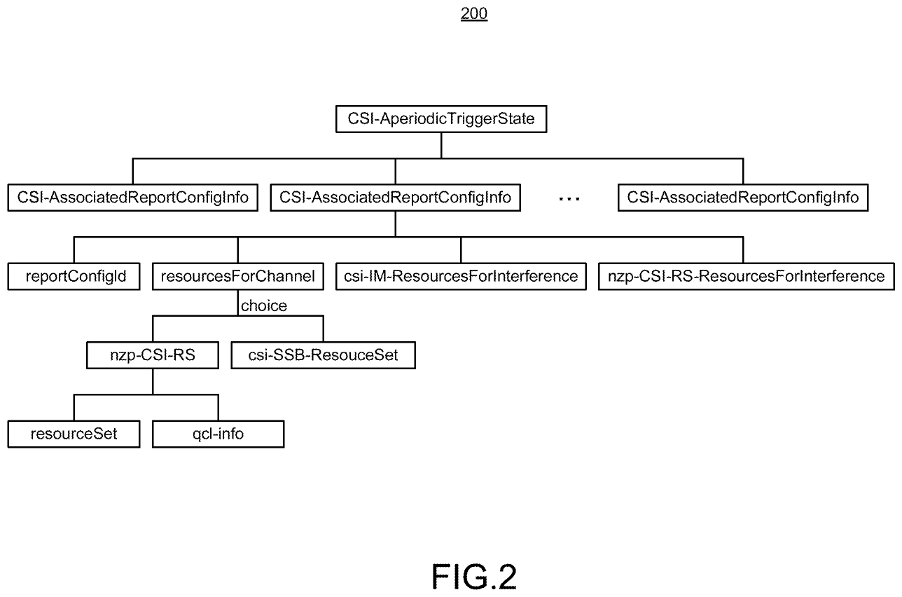

CSI-AperiodicTriggerState: An information element for configuring trigger states for the aperiodic CSI. FIG. 2 is a diagram 200 illustrating an example data structure of an IE CSI-AperiodicTriggerState, according to an example implementation of the present disclosure. It should be noted that the CSI-AperiodicTriggerState may include other IEs, which are not listed in FIG. 2 for the sake of brevity and simplicity. The IEs in the CSI-AperiodicTriggerState may include:
csi-IM-ResourcesForInterference: CSI-IM-ResourceSet for interference measurement. Entry number in the csi-IM-ResourceSetList in the CSI-ResourceConfig indicated by the csi-IM-ResourcesForInterference in the CSI-ReportConfig is indicated by the reportConfigId (value 1 corresponds to the first entry, value 2 corresponds to the second entry, and so on). The indicated CSI-IM-ResourceSet may have exactly the same number of resources as the NZP-CSI-RS-ResourceSet indicated in the nzp-CSI-RS-ResourcesforChannel.
csi-SSB-ResourceSet: CSI-SSB-ResourceSet for channel measurements. Entry number in the csi-SSB-ResourceSetList in the CSI-ResourceConfig may be indicated by the resourcesForChannelMeasurement in the CSI-ReportConfig indicated by the reportConfigId (value 1 corresponds to the first entry, value 2 corresponds to the second entry, and so on).
nzp-CSI-RS-ResourcesForInterference: NZP-CSI-RS-ResourceSet for interference measurement. Entry number in the nzp-CSI-RS-ResourceSetList in the CSI-ResourceConfig may be indicated by nzp-CSI-RS-ResourcesForInterference in the CSI-ReportConfig indicated by the reportConfigId (value 1 corresponds to the first entry, value 2 corresponds to the second entry, and so on).
qcl-info: List of references to TCI-States for providing the QCL source and QCL type for each NZP-CSI-RS-Resource listed in the nzp-CSI-RS-Resources of the NZP-CSI-RS-ResourceSet indicated by the nzp-CSI-RS-ResourcesforChannel. Each TCI-StateId refers to the TCI-State which has this value for tci-StateId and is defined in the tci-StatesToAddModList in the PDSCH-Config included in the BWP-Downlink corresponding to the serving cell and to the DL BWP to which the resourcesForChannelMeasurement (in the CSI-ReportConfig indicated by reportConfigId) belongs. The first entry in the qcl-info-forChannel may correspond to the first entry in the nzp-CSI-RS-Resources of that NZP-CSI-RS-ResourceSet, the second entry in the qcl-info-forChannel may correspond to the second entry in the nzp-CSI-RS-Resources, and so on (see, e.g., the 3GPP TS 38.214 V17.5.0, clause 5.2.1.5.1)
reportConfigId: The reportConfigId of one of the CSI-ReportConfigToAddMod configured in the CSI-MeasConfig.
resourceSet: NZP-CSI-RS-ResourceSet for channel measurements. Entry number in the nzp-CSI-RS-ResourceSetList in the CSI-ResourceConfig may be indicated by the resourcesForChannelMeasurement in the CSI-ReportConfig indicated by the reportConfigId (value 1 corresponds to the first entry, value 2 corresponds to the second entry, and so on).

### CSI Framework

The time and frequency resources that may be used by the UE to report the CSI are controlled by the BS (e.g., a gNB). The CSI may include Channel Quality Indicator (CQI), precoding matrix indicator (PMI), CSI-RS resource indicator (CRI), SS/PBCH Block Resource indicator (SSBRI), layer indicator (LI), rank indicator (RI), L1-RSRP, and L1-SINR.

For the CQI, PMI, CRI, SSBRI, LI, RI, L1-RSRP, the UE may be configured, for example, by the higher layers, with N≥1 CSI-ReportConfig Reporting Settings (N being the number of Reporting Settings), M≥1 CSI-ResourceConfig Resource Settings (M being the number of Resource Settings), and one or two lists of trigger states (e.g., given by the higher layer parameters CSI-AperiodicTriggerStateList and CSI-SemiPersistentOnPUSCH-TriggerStateList).

Each trigger state in the CSI-AperiodicTriggerStateList may include a list of associated CSI-ReportConfigs indicating the Resource Set IDs for the channel and optionally for the interference. Each trigger state in the CSI-SemiPersistentOnPUSCH-TriggerStateList may include one associated CSI-ReportConfig.

Each Reporting Setting CSI-ReportConfig may be associated with a single downlink BWP (e.g., indicated by a higher layer parameter, such as the BWP-Id) given in the associated CSI-ResourceConfig for the channel measurement and may contain the parameter(s) for a CSI reporting band, such as the codebook configuration including codebook subset restriction, time-domain behavior, frequency granularity for CQI and PMI, measurement restriction configurations, and the CSI-related quantities to be reported by the UE, such as the LI, L1-RSRP, L1-SINR, CRI, and SSBRI.

Each CSI Resource Setting CSI-ResourceConfig may include a configuration of a list of S≥1 CSI Resource Sets (e.g., given by a higher layer parameter csi-RS-ResourceSetList, and S being the number of Resource sets), where the list may include references to at least one of the NZP CSI-RS resource set(s) and the SS/PBCH block set(s), or the list may include references to the CSI-IM resource set(s). Each CSI Resource Setting may be located in the DL BWP identified by the higher layer parameter BWP-id, and all the CSI Resource Settings linked to a CSI Report Setting may have the same DL BWP.

### Aperiodic CSI (A-CSI) Triggering Method

A trigger state may be initiated using the CSI request field in the DCI.

When all the bits of the CSI request field in the DCI are set to zero, no CSI is requested.
When the number of configured CSI triggering states in the CSI-AperiodicTriggerStateList is greater than 2^{N}^{_{TS}}−1, where N_{TS} is the number of bits in the DCI CSI request field, the UE may receive a subselection indication, e.g., as described in clause 6.1.3.13 of the 3GPP TS 38.321 V17.4.0, used to map up to 2^{N}^{_{TS}}−1 trigger states to the codepoints of the CSI request field in the DCI. N_{TS} may be configured by the higher layer parameter reportTriggerSize.
When the number of CSI triggering states in CSI-AperiodicTriggerStateList is less than or equal to 2^{N}^{_{TS}}−1, the CSI request field in the DCI may directly indicate the triggering state.

When the aperiodic CSI-RS is used with aperiodic reporting, the CSI-RS offset may be configured per resource set by the higher layer parameter aperiodicTriggeringOffset, including the case that the UE is not configured with a minimumSchedulingOffset for any DL or UL BWP and all the associated trigger states do not have the higher layer parameter qcl-Type set to ‘QCL-TypeD’ in the corresponding TCI states. The CSI-RS triggering offset may have the values of {0, 1, 2, 3, 4, 16, 24}slots. If the UE is not configured with the minimumSchedulingOffset for any DL or UL BWP, and if all the associated trigger states do not have the higher layer parameter qcl-Type set to ‘QCL-TypeD’ in the corresponding TCI states, the CSI-RS triggering offset may be fixed to zero. The aperiodic triggering offset of the CSI-IM may follow the offset of the associated NZP CSI-RS for the channel measurement.

The PUSCH resource for A-CSI may be indicated by the DCI triggering the A-CSI. The PRBs for the PUSCH may be indicated in the frequency domain resource assignment (FDRA) field of the DCI and the symbols for the PUSCH may be indicated by the time domain resource assignment (TDRA) field of the DCI. The UL-SCH indicator field in the DCI may indicate whether the A-CSI is multiplexed with the UL-SCH or not. When the UL-SCH indicator field is set to ‘1’, A-CSI may be multiplexed with the UL-SCH, and the number of REs for the A-CSI may be calculated, e.g., as specified in the 3GPP TS 38.212 V17.5.0, and the slot n+K₂ in which the PUSCH is transmitted may be determined by the entry for K₂ value in a row of the TDRA table, which is indicated by the TDRA field of the DCI that is transmitted in slot n. Otherwise, when the UL-SCH indicator field is set to ‘0’, A-CSI may be mapped on the REs allocated for the PUSCH, and the slot in which the PUSCH is transmitted may be determined by the TDRA field value m of the DCI transmitted in slot n, and the K₂ value may be determined as

$${K}_{2} = {max}_{j} {Y}_{j} ( m + 1 ) ,$$

where Yⱼ, j=0, . . . , N_{Rep}−1 are the corresponding list entries of the higher layer parameter reportSlotOffsetList in the CSI-ReportConfig for the N_{Rep} triggered CSI Reporting Settings and Yⱼ(m+1) is the (m+1)^{th} entry of 1.
The slot where the UE may transmit the PUSCH is determined by K₂ as

$$⌊ n \cdot \frac{{2}^{{μ}_{PUSCH}}}{{2}^{{μ}_{PDCCH}}} ⌋ + {K}_{2} ,$$

where n is the slot with the scheduling DCI, K₂ is based on the numerology of PUSCH, and μ_{PUSCH} and μ_{PDCCH} are the subcarrier spacing configurations for the PUSCH and PDCCH, respectively,

### TCI State

A UE may be configured with a list including up to M TCI state configurations, where each TCI state may contain the parameters for configuring at least one QCL relationship between one or more downlink reference signals and the DM-RS ports of the PDSCH, the DM-RS port of PDCCH, or the CSI-RS port(s) of a CSI-RS resource. The QCL types corresponding to each DL RS may be given, for example, by the higher layer (e.g., RRC layer) parameters for the at least one RS and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

Furthermore, a UE may be configured with a TCI state configuration that contains the parameters for determining a UL TX spatial filter for the UL transmissions. More specifically, when the signals transmitted from different antenna ports share the channels with similar properties, the antenna ports are said to be QCL signals. Basically, the QCL concept is introduced to help the UE with a precise channel estimation, frequency offset error estimation, and synchronization procedures.

### Unified TCI Framework

To facilitate more efficient (lower latency and overhead) DL/UL beam management to support a larger number of configured TCI states, a unified TCI framework for beam indication may result in some benefits of low complexity and simplified controlling mechanisms. More specifically, through the unified indication, the DL or UL channels/signals may share the same indicated TCI state to reduce the signaling overhead, and different channels and/or reference signals may share similar channel properties. The unified indication may be used to indicate a common TCI state for the DL channels (e.g., including a PDCCH, PDSCH, and/or DL reference signal), a common TCI state for the UL channels (e.g., including a PUCCH, PUSCH, and/or UL reference signal), and/or a common TCI state for both DL and UL channels. The unified indication for a common TCI state for the DL channels may be referred to as a “DL only TCI state”, a “DL TCI state” or a “DL only”. The unified indication for a common TCI state for the UL channels may be referred to as a “UL only TCI state”, a “UL TCI state” or a “UL only”. The unified indication for a common TCI state for both DL and UL channels may be referred to as a “joint TCI state mode”, a “joint TCI state” or a “joint indication”. The “DL only TCI state” and “UL only TCI state” may also be referred to as a “separate TCI state mode” or a “separate TCI state”, as opposed to the “joint TCI state mode” or “joint TCI state”.

Network energy saving is of a great importance in the field to reduce the environmental impacts (e.g., greenhouse gas emissions). The environmental impact of the 5G networks needs to stay under control, and solutions to improve the network energy savings need to be developed.

In the NR system, the existing TCI state indication procedures may need to be enhanced when considering the spatial pattern adaptation. The legacy TCI configuration may be invalid due to the dynamic spatial and power adaptation. An enhanced TCI state switching mechanism corresponding to the dynamic adaptation may need to be supported.

Using Type-1 or Type-2 spatial adaptation in the network may lead to a reduction in the antenna ports or a change in the beam width. These kinds of adaptation may lead to the change of T states of signals and channels. Mechanisms to update parameters for a given CSI-RS resource configuration, such as updating the TCI state stored in the UE, may be needed. The network may need an efficient method to configure or indicate the change of TC state. The present disclosure will address the impact of the NES on the TCI state, the TCI framework update, R15 L1/L2 signaling for each TCI framework, R15 unified TCI update of the NES adaptation, R17 L1/L2 signaling for each TCI framework, and fast adaptation of the NES on the TCI state update.

### Impact of NES on the TCI State

Table 1 below illustrates an example data structure of a TCI state, according to an example implementation of the present disclosure. For spatial or power domain adaptation, the QCL property in the T state may be affected by the Type-1 and Type-2 adaptations.

TABLE 1
-- ASN1START
-- TAG-TCI-STATE-START

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

...,
}

| QCL-Info ::= | SEQUENCE { | |
|---|---|---|
| cell | ServCellIndex | OPTIONAL, -- Need R |
| bwp-Id | BWP-Id | OPTIONAL, -- Cond CSI-RS-Indicated |

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}
-- TAG-TCI-STATE-STOP
-- ASN1STOP

### Impact of the Type-1 Spatial Adaptation

For the Type-1 spatial adaptation, the number of CSI-RS ports may be reduced. The QCL type D, which may correspond to the spatial Rx parameter, may be affected and changed after the Type-1 spatial adaptation is performed. In some implementations, the QCL information of the CSI-RS resources (e.g., the qcl-InfoPeriodicCSI-RS in the nzp-CSI-RS-Resource) may need to be adapted.

### Impact of the Type-2 Spatial Adaptation

For the Type-2 spatial adaptation, the beam pattern or the power of the beam may be changed. The QCL property, including the doppler spread, the average delay, and the spatial Rx parameter may be changed. The corresponding QCL type A, B, C and D may be affected and changed. In some implementations, the TCI state (e.g., in the parameter tci-states-ToAddModdList) may be updated after the Type-2 spatial adaptation is performed.

### TCI Framework Update

### TCI Framework #1—Additional Indication in the TCI State

For a legacy TCI state reference indication, a reference signal (e.g., a CSI-RS) may be enough to indicate the QCL relationship between two antenna ports. That is, the properties of the channel over which a symbol on one antenna port is conveyed may be inferred from the channel over which a symbol on the other antenna port is conveyed. Under the NES condition/operation/adaptation, more than one spatial pattern may correspond to a CSI-RS resource. An indication to a specific spatial pattern may be used to further indicate the QCL relationship between the two antenna ports.

In some implementations, a new IE in a TCI state pattern ID or a sub-configuration ID may be introduced and/or added. When the NES adaptation is applied, the L1/L2 signaling may further indicate a candidate pattern ID or a sub-configuration ID in the same TCI state ID. For example, the UE may update the TCI states stored in the UE based on the pattern ID or the sub-configuration ID carried in a MAC CE or a DCI format.

Table 2 below illustrates an example data structure of a TCI state including a QCL field under the TCI framework #1, according to an example implementation of the present disclosure. The QCL field (e.g., the qcl-Type1) may indicate a reference signal (e.g., the referenceSignal csi-rs) and a QCL type (e.g., the qcl-Type TypeA). The TCI state may include a first QCL field (e.g., the qcl-Type1) and a second QCL field (e.g., the qcl-Type2), where the first QCL type (e.g., the qcl-Type typeA) indicated by the first QCL field may be different from the second QCL type (e.g., the qcl-Type typeD) indicated by the second QCL field.

TABLE 2

```
{
  tci-StateId n,
  qcl-Type1
  {
    bwp-Id b,
    referenceSignal csi-rs : k
    pattern/sub-configuration ID 1
    pattern/sub-configuration ID 2
    pattern/sub-configuration ID ...
    qcl-Type typeA
  }
  qcl-Type2
  {
    bwp-Id b,
    referenceSignal csi-rs : k
    pattern/sub-configuration ID
    qcl-Type typeD
  }
}
```

A reference signal (e.g., the referenceSignal csi-rs k) may be configured in a TCI state (e.g., the TCI state n). Before the NES adaptation, the network may preconfigure the candidate patterns (e.g., pattern ID 1 and pattern ID 2) in the TCI state n to inform the UE of the corresponding QCL relation adaptation. The flexibility of the TCI framework #1 may be larger than the TCI framework #2 and the TCI framework #3, which is described below, because the TCI framework #1 may have more precise indication of the QCL information to a TCI state than the TCI framework #2 and the TCI framework #3.

### TCI Framework #2—Candidate CSI-RS Resources as Reference Signal

For the NES conditions, the network may need a specific QCL relationship indication of the spatial pattern of two antenna ports. In some implementations, there may be candidate reference resources in a TC state. Table 3 below illustrates an example data structure of a TCI state, including a QCL field, under the TCI framework #2, according to an example implementation of the present disclosure. The QCL field (e.g., the qcl-Type1) may indicate a reference signal (e.g., the referenceSignal csi-rs) and a QCL type (e.g., the qcl-Type). The TCI state may include a first QCL field (e.g., the qcl-Type1) and a second QCL field (e.g., the qcl-Type2), where the first QCL type (e.g., the qcl-Type typeA) indicated by the first QCL field may be different from the second QCL type (e.g., the qcl-Type typeD) indicated by the second QCL field.

TABLE 3

```
{
  tci-StateId n,
  qcl-Type1
  {
    bwp-Id b,
    referenceSignal csi-rs : k
    candidate referenceSignal csi-rs k′
    candidate referenceSignal csi-rs k″
    qcl-Type typeA
  }
  qcl-Type2
  {
    bwp-Id b,
    referenceSignal csi-rs : k
    candidate referenceSignal csi-rs k′
    candidate referenceSignal csi-rs k″
    qcl-Type typeD
  }
}
```

The network may preconfigure the candidate reference signals (e.g., the candidate referenceSignal csi-rs) in the TCI state (e.g., the tci-StateId n) and the same QCL field (e.g., the qcl-Type1). When the NES adaptation is applied, the L1/L2 signaling may further indicate the reference signal in the same TCI state and the same QCL field. For example, the UE may update the TCI states stored in the UE based on the reference signal indicated in a MAC CE or a DCI format.

For example, a reference signal (e.g., the referenceSignal csi-rs k) may be configured in a TCI state (e.g., the TCI state n). The network may preconfigure the candidate referenceSignal csi-rs k′ and candidate referenceSignal csi-rs k″ in the TCI state n when the NES adaptation is applied. The efficiency of the TCI framework #2 may be larger than the TCI framework #1 and the TCI framework #3, because the TCI framework #2 may not need to rebuild or repeat the TCI framework.

TCI Framework #3—Candidate Sets of TCI State(s) Associated with DL/UL Signal/Channel

For the NES conditions, the network may need a specific QCL relationship indication of the spatial pattern of the two antenna ports. Some implementations may include candidate TCI states. Table 4 below illustrates an example data structure of a TCI state and the candidate TCI states under the TCI framework #3, according to an example implementation of the present disclosure.

TABLE 4

```
{
  tci-StateId n,
  qcl-Type1
  {
      bwp-Id b,
      referenceSignal csi-rs : k
      qcl-Type typeA
  }
  qcl-Type 2
  {
      bwp-Id b,
      referenceSignal csi-rs : k
      qcl-Type typeD
    }
}
{
  candidate-tci-StateId n+1,
  qcl-Type1
  {
      bwp-Id b,
      referenceSignal csi-rs : k+1
      qcl-Type typeB
  }
  qcl-Type 2
  {
      bwp-Id b,
      referenceSignal csi-rs : k+1
      qcl-Type typeD
    }
}
{
  candidate-tci-StateId n+2,
  qcl-Type1
  {
      bwp-Id b,
      referenceSignal csi-rs : k+2
      qcl-Type typeC
  }
  qcl-Type 2
  {
      bwp-Id b,
      referenceSignal csi-rs : k+2
      qcl-Type typeD
    }
}
```

The candidate TCI state (e.g., the candidate-tci-StateId n+1) may include a different reference signal (e.g., the referenceSignal csi-rs: k+1), and a different QCL type (e.g., the qcl-Type typeB), than those in the TCI state n. When the NES adaptation is applied, the L1/L2 signaling may further indicate the candidate TCI state. For example, the UE may update the TCI states stored in the UE based on the candidate TCI state carried in a MAC CE or a DCI format.

For example, a reference signal (e.g., the referenceSignal csi-rs k) and a QCL type (e.g., the qcl-TypeA) may be configured in a TCI state (e.g., the TCI state n). The network may preconfigure a candidate TCI state with the state ID n+1 including the referenceSignal csi-rs: k+1 and the qcl-Type typeB. The network may also preconfigure another candidate TCI state with the state ID n+2 including the referenceSignal csi-rs: k+2 and the qcl-Type typeC.

The overall TCI state number may be increased by applying the TCI framework #3. The signaling overhead of the TCI framework #3 may be lower than the TCI framework #1 and the TCI framework #2, because the TCI framework #3 may not need to further indicate the QCL type in the TCI state.

### R15 L1/L2 Signaling for Each TCI Framework

Periodic CSI-RS resources may be configured and initiated via the RRC signaling (e.g., the RRCReconfiguration message). Semi-persistent CSI-RS resources may be configured via the RRC and may be activated by a MAC CE. Aperiodic CSI-RS resources may be configured via the RRC and may be triggered by the DCI. The configured CSI-RS resources may be activated/deactivated (e.g., by the MAC CE) or triggered (e.g., by the DCI). In some implementations, the L1/L2 signaling may be used to update a subset of parameters, such as the TCI state, for an already configured CSI-RS resource.

### L1/L2 Signaling in the TCI Framework #1

### Periodic CSI-RS

Table 5 below illustrates an example data structure of a periodic CSI-RS resource (e.g., the NZP-CSI-RS-Resource in the MeasConfig), according to an example implementation of the present disclosure.

TABLE 5
-- ASN1START
-- TAG-NZP-CSI-RS-RESOURCE-START

| NZP-CSI-RS-Resource ::= | SEQUENCE { | |
|---|---|---|
| nzp-CSI-RS-ResourceId | NZP-CSI-RS-ResourceId, | |
| resourceMapping | CSI-RS-ResourceMapping, | |
| powerControlOffset | INTEGER (−8..15), | |
| powerControlOffsetSS | ENUMERATED{db−3, db0, db3, db6} | OPTIONAL, -- Need R |
| scramblingID | ScramblingId, | |
| periodicityAndOffset | CSI-ResourcePeriodicityAndOffset | OPTIONAL, -- Cond |

PeriodicOrSemiPersistent

| | | |
|---|---|---|
| qcl-InfoPeriodicCSI-RS | TCI-StateId | OPTIONAL, -- Cond Periodic |

...
}
-- TAG-NZP-CSI-RS-RESOURCE-STOP
-- ASN1STOP

A reference periodic CSI-RS may include a reference to a TCI state for providing the QCL source and the QCL type. For a periodic CSI-RS, the QCL source may be an SSB or another periodic CSI-RS. The TCI state having the value for the tci-StateId may be defined in the tci-StatesToAddModList in the PDSCH configuration (e.g., the PDSCH-Config).

In some implementations, the TCI state of the periodic CSI-RS may be configured via the RRC signaling. In addition, the RRC signaling may be used to configure and indicate the pattern ID or the sub-configuration ID in the TCI framework #1.

In some implementations, the network may use the L1/L2 signaling (e.g., a MAC CE or a DCI format) to further indicate the TCI state of the periodic CSI-RS resource in the TCI framework #1.

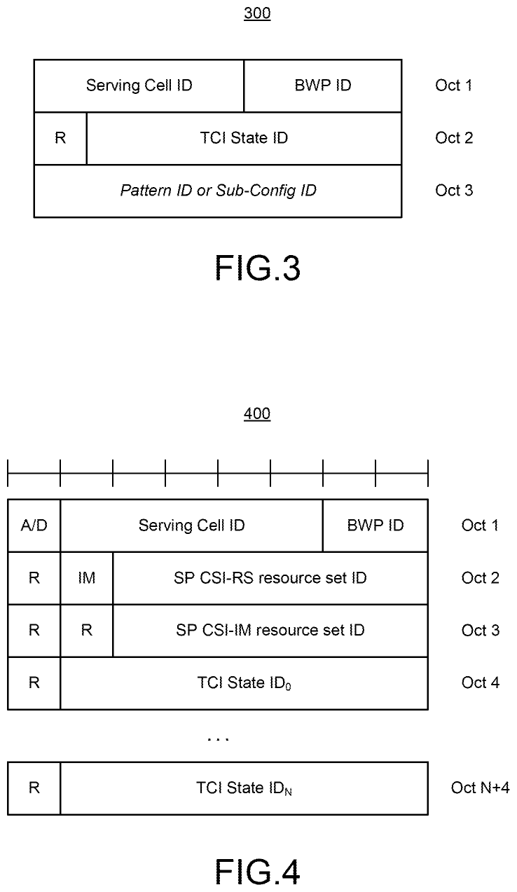

FIG. 3 is a diagram illustrating a MAC CE 300 for indicating a pattern of the NES adaptation in the TCI framework #1, according to an example implementation of the present disclosure. The MAC CE 300 may include a field Pattern ID or Sub-Confg ID (e.g., in octet 3) for indicating the pattern of the NES adaptation in the TCI framework #1.

In some implementations, a DCI format may include a field Pattern ID or a Sub-ConfigID for indicating a specific pattern related to the TCI state. The TCI state may be related to the qcl-infoPeriodicCSI-RS and pre-configured in the TCI framework #1. In some implementations, the field Pattern ID or Sub-ConfigID in the DCI format may include an index. For example, index 0 may correspond to pattern ID 0, index 1 may correspond to pattern ID 1, and so on. The UE may update the TCI states stored in the UE based on the field Pattern ID or Sub-Config ID in the DCI format.

### Semi-Persistent CSI-RS

FIG. 4 is a diagram illustrating a MAC CE 400 for activating/deactivating a SP CSI-RS/CSI-IM resource set, according to an example implementation of the present disclosure. The field TCI State IDᵢ (e.g., in each octet starting from octet 4) may be indicated for the semi-persistent CSI-RSs in the resource sets, where i is an integer, including 0. This field may include the TCI-StateId, as specified in the 3GPP TS 38.331, of a TCI State, which may be used as the QCL source for the resource within the semi-persistent NZP CSI-RS resource set indicated by the field SP CSI-RS resource set ID. For example, TCI State ID₀ may indicate the TCI state for the first resource within the set, TCI State ID₁ may indicate the TCI state for the second one, and so on. The length of the field TCI State IDᵢ may be 7 bits. In some implementations, if the A/D field is set to 0, the field TCI State IDᵢ (e.g., in each octet starting from octet 4) may not be present.

The TCI state of the semi-persistent CSI-RS may be configured in the tci-StatesToAddModList in the PDSCH-Config. In some implementations, the network may use a modified version of MAC CE to further indicate the TCI state of each resource in the resource set for the TCI framework #1.

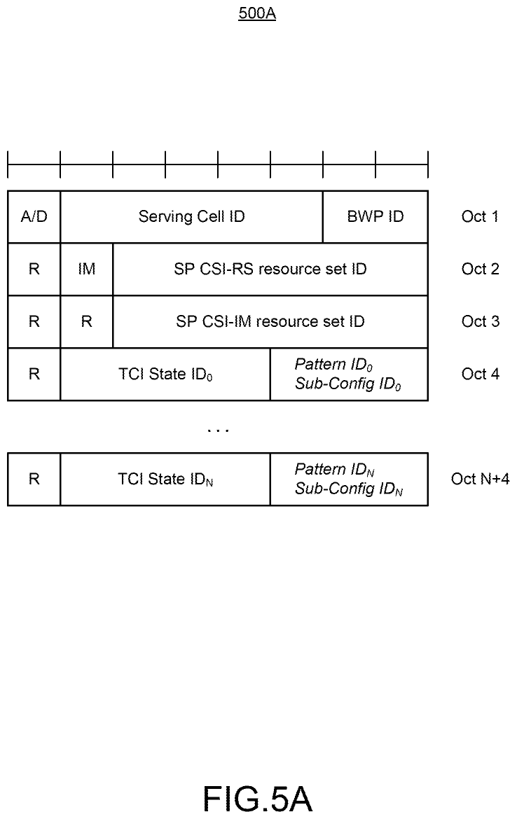

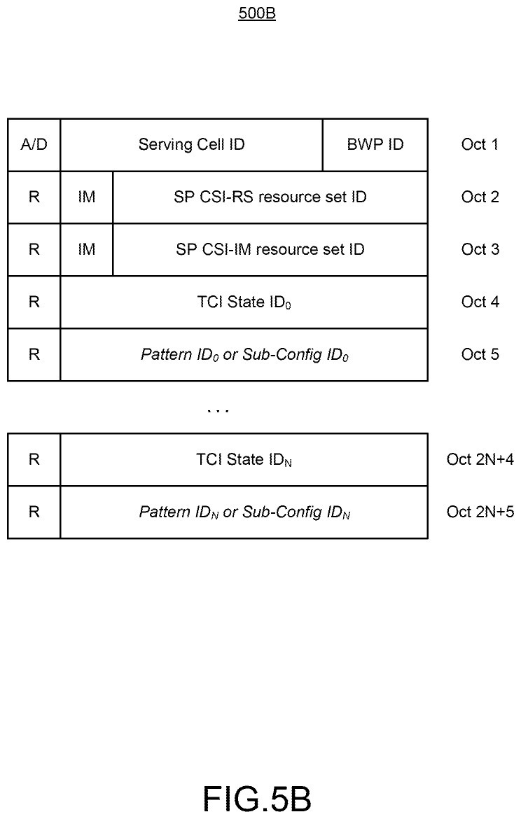

FIG. 5A is a diagram illustrating a MAC CE 500A for activating/deactivating a SP CSI-RS/CSI-IM resource set and indicating a pattern of the NES adaptation in the TCI framework #1, according to an example implementation of the present disclosure. In the MAC CE 500A, a new field Pattern IDᵢ or Sub-Config IDᵢ may be added (e.g., be attached) after the field TCI State IDᵢ. The new field may indicate the Pattern ID or Sub-Config ID in the TCI framework #1. The length of the new field may be x bits, and the length of the TCI State ID, field may be 7-x bits, where x is a positive integer. In some implementations, the value of x may be configured by a higher layer parameter.

FIG. 5B is a diagram illustrating a MAC CE 500B for activating/deactivating a SP CSI-RS/CSI-IM resource set and indicating a pattern of the NES adaptation in the TCI framework #1, according to an example implementation of the present disclosure. In the MAC CE 500B, a new field Pattern IDᵢ or Sub-ConfigIDᵢ may be added as a new octet after the field TCI State IDᵢ. The new field may indicate the Pattern ID or Sub-Config ID in the TCI framework #1.

### Aperiodic CSI-RS

As shown in FIG. 2, the CSI-AperiodicTriggerState may include an IE CSI-AssociatedReportConfigInfo. In some implementations, the TCI state of the aperiodic CSI-RS may be configured via the RRC signaling (e.g., in the CSI-AssociatedReportConfigInfo). In addition, the RRC signaling may be used to configure and indicate the pattern ID or sub-configuration ID in the TCI framework #1. Table 6 below illustrates an example data structure of the CSI-AssociatedReportConfigInfo, according to an example implementation of the present disclosure.

TABLE 6
CSI-AssociatedReportConfigInfo ::= SEQUENCE {

| | |
|---|---|
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS-ResourceSetsPerConfig), |
| qcl-info | SEQUENCE (SIZE(1..maxNrofAP-CSI-RS-ResourcesPerSet)) OF TCI- |

StateId

OPTIONAL -- Cond Aperiodic

},

| | |
|---|---|
| csi-SSB-ResourceSet | INTEGER (1..maxNrofCSI-SSB-ResourceSetsPerConfig) |

},

| | |
|---|---|
| csi-IM-ResourcesForInterference | INTEGER(1..maxNrofCSI-IM-ResourceSetsPerConfig) |

The qcl-info may list a set of references to the TCI states for providing the QCL source and QCL type for each NZP CSI-RS resource listed in the nzp-CSI-RS-Resources of the NZP-CSI-RS-ResourceSet indicated by the resourceSet within the nzp-CSI-RS. Each TCI-StateId may refer to a TCI-State having this ID value for the field tci-StateId. The TCI-State may be defined in the tci-StatesToAddModList in the PDSCH-Config included in the BWP-Downlink corresponding to the serving cell and the DL BWP to which the resourcesForChannelMeasurement (e.g., in the CSI-ReportConfig indicated by the reportConfigId) belongs. The first entry in the qcl-info may correspond to the first entry in the nzp-CSI-RS-Resources of the NZP-CSI-RS-ResourceSet, the second entry in the qcl-info may correspond to the second entry in the nzp-CSI-RS-Resources, and so on.

### PDCCH DMRS

Table 7 below illustrates an example data structure of a control resource set (e.g., the IE ControlResourceSet), according to an example implementation of the present disclosure.

TABLE 7
-- ASN1START
-- TAG-CONTROLRESOURCESET-START

| ControlResourceSet ::= | SEQUENCE { | |
|---|---|---|
| controlResourceSetId | ControlResourceSetId, | |
| frequencyDomainResources | BIT STRING (SIZE (45)), | |
| duration | INTEGER (1..maxCoReSetDuration), | |
| cce-REG-MappingType | CHOICE { | |
| interleaved | SEQUENCE { | |
| reg-BundleSize | ENUMERATED {n2, n3, n6}, | |
| interleaverSize | ENUMERATED {n2, n3, n6}, | |
| shiftIndex | INTEGER(0..maxNrofPhysicalResourceBlocks-1) | OPTIONAL -- Need |

S
},

| | |
|---|---|
| nonInterleaved | NULL |

},

| | |
|---|---|
| precoderGranularity | ENUMERATED {sameAsREG-bundle, allContiguousRBs}, |
| tci-StatesPDCCH-ToAddList | SEQUENCE(SIZE (1..maxNrofTCI-StatesPDCCH)) OF TCI-StateId |

OPTIONAL, -- Cond NotSIB-initialBWP

| | |
|---|---|
| tci-StatesPDCCH-ToReleaseList | SEQUENCE(SIZE (1..maxNrofTCI-StatesPDCCH)) OF TCI-StateId |

OPTIONAL, -- Cond NotSIB-initialBWP

| | | |
|---|---|---|
| tci-PresentInDCI | ENUMERATED {enabled} | OPTIONAL, -- Need S |
| pdcch-DMRS-ScramblingID | INTEGER (0..65535) | OPTIONAL, -- Need S |

...,
}
-- TAG-CONTROLRESOURCESET-STOP
-- ASN1STOP

The network may use the tci-StatesPDCCH-ToAddList to configure a list of TCI states, as a possible source RS signal. The tci-StatesPDCCH-ToAddList may be a subset of the TCI states defined in the pdsch-Config included in the BWP-DownlinkDedicated corresponding to the serving cell and the DL BWP to which the ControlResourceSet belongs. The TCI states may be used for providing the QCL relationships between the DL RS(s) in an RS set and the PDCCH DMRS ports. The network may configure at most the maxNrofTCI-StatesPDCCH entries for the tci-StatesPDCCH-ToAddList.

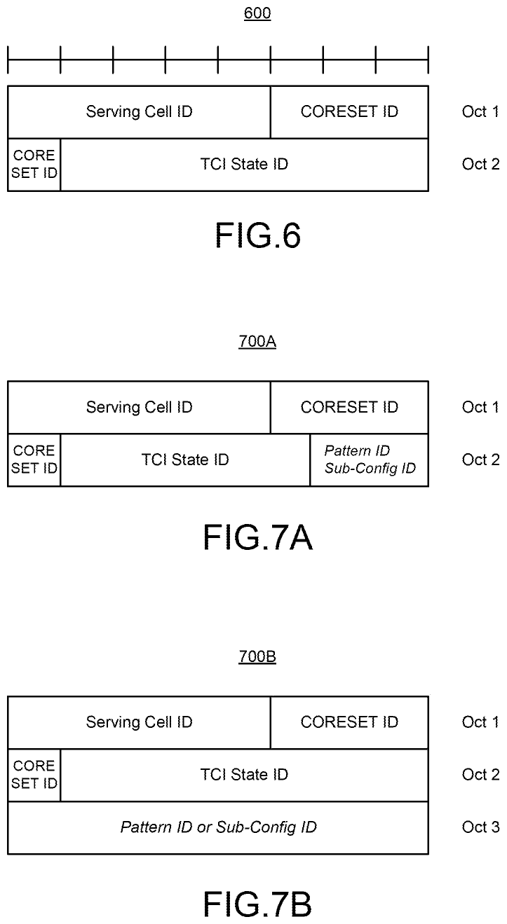

FIG. 6 is a diagram illustrating a MAC CE 600 for indicating a TCI state for a UE-specific PDCCH, according to an example implementation of the present disclosure. In the MAC CE 600, the field TCI State ID may indicate the TCI state, identified by the TCI-StateId, as specified in the 3GPP TS 38.331, applicable to the CORESET identified by the field CORESET ID (e.g., in the last three bits of octet 1 and the first bit of octet 2). If the field CORESET ID is set to 0, the field TCI State ID may indicate a state of the first 64 TCI states configured by the tci-StatesToAddModList and tci-StatesToReleaseList in the PDSCH-Config in the active (DL) BWP. If the field CORESET ID is set to a value other than 0, the field TCI State ID may indicate a TCI state configured by the tci-StatesPDCCH-ToAddList and tci-StatesPDCCH-ToReleaseList in the controlResourceSet identified by the field CORESET ID. The length of the field TCI State ID may be 7 bits.

The TCI state of the PDCCH DMRS may be configured in the tci-StatesPDCCH-ToAddList defined in the pdsch-Config. In some implementations, the network may use a modified version of MAC CE to further indicate the TCI state of the PDCCH DMRS.

FIG. 7A is a diagram illustrating a MAC CE 700A for indicating a TCI state for a UE-specific PDCCH and indicating a pattern of the NES adaptation in the TCI framework #1, according to an example implementation of the present disclosure. In the MAC CE 700A, a new field Pattern ID or Sub-ConfigID may be added after the field TCI state ID. The new field may indicate the Pattern ID or Sub-Config ID in the TCI framework #1. The length of the new field may be x bits, and the length of the field TCI State ID may be 7-x bits, where x is a positive integer. In some implementations, the value of x may be configured by a higher layer parameter.

FIG. 7B is a diagram illustrating a MAC CE 700B for indicating a TCI state for a UE-specific PDCCH and indicating a pattern of the NES adaptation in the TCI framework #1, according to an example implementation of the present disclosure. In the MAC CE 700B, a new field Pattern ID or Sub-Config ID may be added as a new octet after the field TCI State ID. The new field may indicate the Pattern ID or Sub-ConfigID in the TCI framework #1.

### PDSCH DMRS

Table 8 below illustrates an example data structure of a PDSCH configuration (e.g., the PDSCH-Config), according to an example implementation of the present disclosure.

TABLE 8

| PDSCH-Config ::= | SEQUENCE { | |
|---|---|---|
| dataScramblingIdentityPDSCH | INTEGER (0..1023) | OPTIONAL, - |

- Need S

| | |
|---|---|
| dmrs-DownlinkForPDSCH-MappingTypeA | SetupRelease { DMRS-DownlinkConfig } |

OPTIONAL, -- Need M

| | |
|---|---|
| dmrs-DownlinkForPDSCH-MappingTypeB | SetupRelease { DMRS-DownlinkConfig } |

OPTIONAL, -- Need M

| | |
|---|---|
| tci-StatesToAddModList | SEQUENCE (SIZE(1..maxNrofTCI-States)) OF TCI-State |

OPTIONAL, -- Need N

| | |
|---|---|
| tci-StatesToReleaseList | SEQUENCE (SIZE(1..maxNrofTCI-States)) OF TCI-StateId |

OPTIONAL, -- Need N

| | | |
|---|---|---|
| vrb-ToPRB-Interleaver | ENUMERATED {n2, n4} | OPTIONAL, - |

- Need S

| | |
|---|---|
| resourceAllocation | ENUMERATED { resourceAllocationType0, resourceAllocationType1, |

dynamicSwitch},

| | |
|---|---|
| pdsch-TimeDomainAllocationList | SetupRelease { PDSCH-TimeDomainResourceAllocationList } |

OPTIONAL, -- Need M

| | | |
|---|---|---|
| pdsch-AggregationFactor | ENUMERATED { n2, n4, n8 } | OPTIONAL, |

-- Need S

| | |
|---|---|
| rateMatchPatternToAddModList | SEQUENCE (SIZE (1..maxNrofRateMatchPatterns)) OF |

RateMatchPattern OPTIONAL, -- Need N

| | |
|---|---|
| rateMatchPatternToReleaseList | SEQUENCE (SIZE (1..maxNrofRateMatchPatterns)) OF |

RateMatchPatternId OPTIONAL, -- Need N

| | | |
|---|---|---|
| rateMatchPatternGroup1 | RateMatchPatternGroup | OPTIONAL, -- |

Need R

| | | |
|---|---|---|
| rateMatchPatternGroup2 | RateMatchPatternGroup | OPTIONAL, -- |

Need R

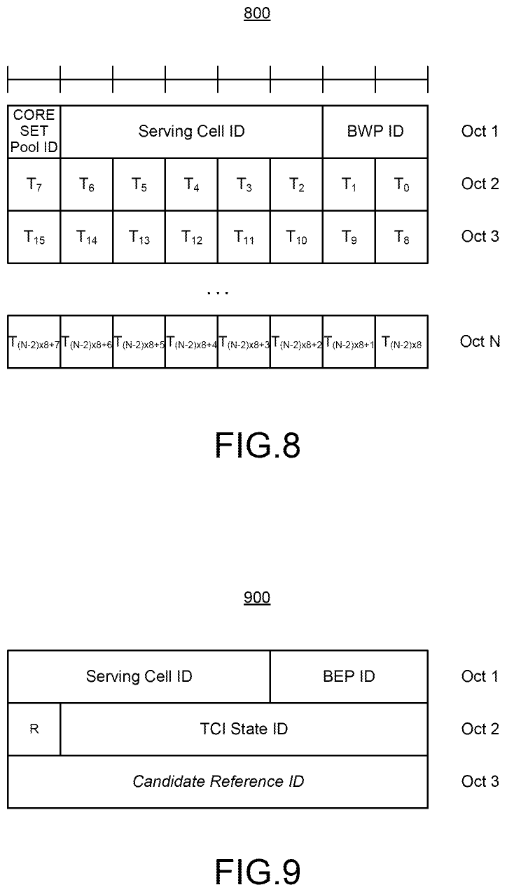

FIG. 8 is a diagram illustrating a MAC CE 800 for activating/deactivating TCI states for a UE-specific PDSCH, according to an example implementation of the present disclosure. In the MAC CE 800, the field Tᵢ may indicate the activation/deactivation status of the TCI state with the TCI-StateId equal to i, as specified in the 3GPP TS 38.331. The field T, set to 1 may indicate that the TCI state with the TCI-StateId equal to i may be activated and mapped to the codepoint of the DCI TCI field, as specified in the 3GPP TS 38.214. The T field Tᵢ set to 0 may indicate that the TCI state with the TCI-StateId equal to i may be deactivated and may not be mapped to the codepoint of the DCI TCI field. The codepoint to which the TCI state is mapped may be determined by its ordinal position among all the TCI states with the field Tᵢ set to 1. For example, the first TCI state with the field Tᵢ set to 1 may be mapped to the codepoint value 0, the second TCI State with the field Tᵢ set to 1 may be mapped to the codepoint value 1, and so on. The maximum number of activated TCI states may be 8.

If a higher layer parameter tci-PresentInDCI is set as ‘enabled’, the TCI field in the DCI in the scheduling component carrier may point to the activated TCI states in the scheduled component carrier or DL BWP. When the PDSCH is scheduled by a DCI format 1_1, the UE may use the TCI-State according to the value of the TCI field in the detected PDCCH with the DCI for determining PDSCH antenna port quasi co-location.

The codepoint relationship of the DCI TCI field may be redesigned and enhanced in the TCI framework #1. In some implementations, a DCI format may include a field Pattern ID or Sub-Config ID for indicating a specific pattern related to the TCI state. In some implementations, the field Pattern ID or Sub-ConfigID in the DCI format may include an index. For example, index 0 may correspond to pattern ID 0, index 1 may correspond to pattern ID 1, and so on. The UE may update the TCI states stored in the UE based on the field Pattern ID or Sub-Config ID in the DCI format.

### L1/L2 Signaling in the TCI Framework #2

### Periodic CSI-RS

In some implementations, the TCI state of the periodic CSI-RS may be configured by the RRC signaling. In addition, the RRC signaling may be used to configure the candidate referenceSignal csi-rs in the TCI framework #2.

In some implementations, the network may use the L1/L2 signaling (e.g., a MAC CE or a DCI format) to further indicate the TCI state of the periodic CSI-RS resource in the TCI framework #2.

FIG. 9 is a diagram illustrating a MAC CE 900 for indicating a pattern of the NES adaptation in the TCI framework #2, according to an example implementation of the present disclosure. The MAC CE 900 may include a field Candidate Reference ID (e.g., in octet 3) for indicating the pattern of the NES adaptation in the TCI framework #2.

In some implementations, a DCI format may include a field Candidate Reference ID for indicating a specific pattern related to the TCI state. The TCI state may be related to the qcl-infoPeriodicCSI-RS and may be pre-configured in the TCI framework #2. In some implementations, the field Candidate Reference ID in the DCI format may include an index. For example, index 0 may correspond to candidate reference ID 0, index 1 may correspond to candidate reference ID 1, and so on. The UE may update the TCI states stored in the UE based on the field Candidate Reference ID in the DCI format.

### Semi-Persistent CSI-RS

The TCI state of the semi-persistent CSI-RS may be configured in the tci-StatesToAddModList in the PDSCH-Config. In some implementations, the network may use a modified version of MAC CE to further indicate a candidate reference signal of the TCI state corresponding to the same resource in the resource set for the TCI framework #2.

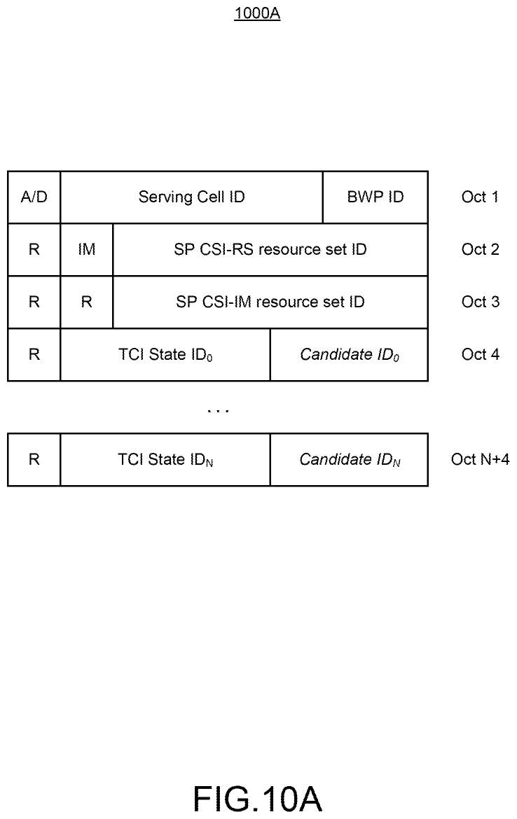

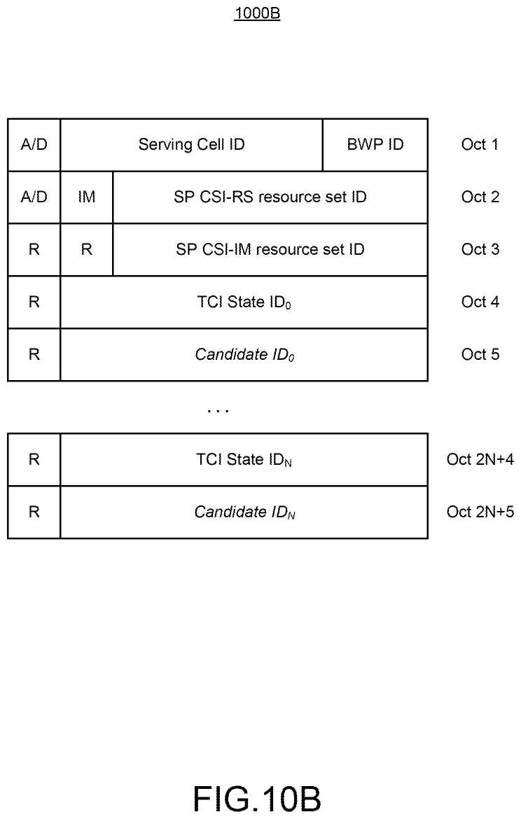

FIG. 10A is a diagram illustrating a MAC CE 1000A for activating/deactivating a SP CSI-RS/CSI-IM resource set and indicating a pattern of the NES adaptation in the TCI framework #2, according to an example implementation of the present disclosure. In the MAC CE 1000A, a new field Candidate IDᵢ may be attached after the field TCI state IDᵢ. The new field may indicate the Candidate ID in the TCI framework #2. The length of the field Candidate IDᵢ may be x bits, and the length of the TCI State IDᵢ field may be 7-x bits, where x is a positive integer. In some implementations, the value of x may be configured by a higher layer parameter.

FIG. 10B is a diagram illustrating a MAC CE 1000B for activating/deactivating a SP CSI-RS/CSI-IM resource set and indicating a pattern of the NES adaptation in the TCI framework #2, according to an example implementation of the present disclosure. In the MAC CE 1000B, a new field Candidate IDᵢ may be added as a new octet after the field TCI state IDᵢ. The new field may indicate the Candidate ID in the TCI framework #2.

### Aperiodic CSI-RS

In some implementations, the TCI state of the aperiodic CSI-RS may be configured via RRC signaling (e.g., in the CSI-AssociatedReportConfigInfo). In addition, RRC signaling may be used to configure and indicate the Candidate ID in the TCI framework #2.

### PDCCH DMRS

The TCI state of the PDCCH DMRS may be configured in the tci-StatesPDCCH-ToAddList defined in the pdsch-Config. In some implementations, the network may use a modified version of MAC CE to further indicate the TCI state of the PDCCH DMRS.

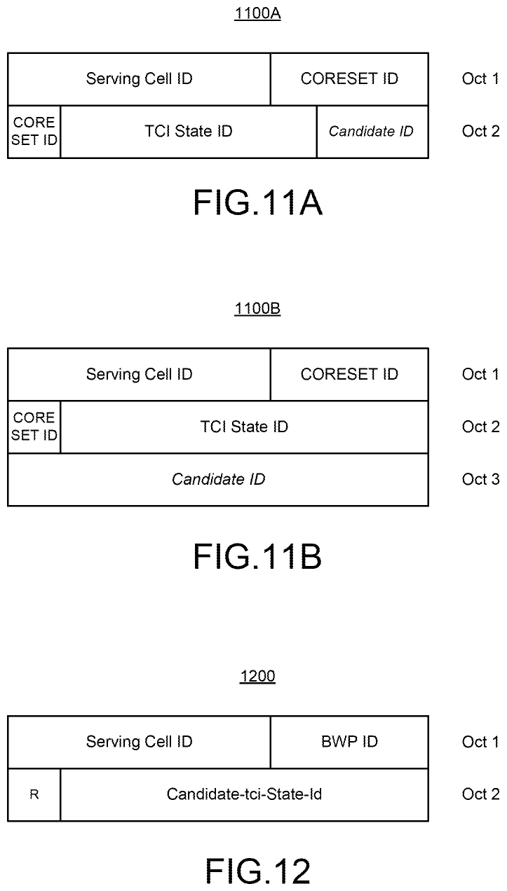

FIG. 11A is a diagram illustrating a MAC CE 1100A for indicating a TCI state for a UE-specific PDCCH and indicating a pattern of the NES adaptation in the TCI framework #2, according to an example implementation of the present disclosure. In the MAC CE 1100A, a new field Candidate ID may be attached after the field TCI state ID. The new field may indicate the Candidate ID in the TCI framework #2. The length of the new field Candidate ID may be x bits, and the length of the field TCI State ID may be 7-x bits, where x is a positive integer. In some implementations, the value of x may be configured by a higher layer parameter.

FIG. 11B is a diagram illustrating a MAC CE 1100B for indicating a TCI state for a UE-specific PDCCH and indicating a pattern of the NES adaptation in the TCI framework #2, according to an example implementation of the present disclosure. In the MAC CE 1100B, a new field Candidate ID may be added as a new octet after the field TCI State ID. The new field may indicate the Candidate ID in the TCI framework #2.

### PDSCH DMRS

The codepoint relationship of the DCI TCI field may be redesigned and enhanced in the TCI framework #2. In some implementations, a DCI format may include a field Candidate ID for indicating a specific candidate related to the TCI state. In some implementations, the field Candidate ID in the DCI format may include an index. For example, index 0 may correspond to candidate ID 0, index 1 may correspond to candidate ID 1, and so on. The UE may update the TCI states stored in the UE based on the field Candidate Reference ID in the DCI format.

### L1/L2 Signaling in the TCI Framework #3

In the TCI framework #3, there may be candidate TCI states as shown in Table 4 above. In some implementations, a new list may be introduced for the candidate TCI states. The new list may be a subset of the tci-StatesToAddList defined in the pdsch-Config.

In some implementations, the network may reuse the tci-StatesToAddList for the candidate TCI states in the TCI framework #3. In some implementations, there may be a new list tci-CandidateStatesToAddList for the candidate TCI states in the TCI framework #3. Table 9 below illustrates an example data structure of a list for the candidate TCI states in the TCI framework #3, according to an example implementation of the present disclosure.

TABLE 9

```
TCI-CandidateStatesToAddModList
{
  candidate-tci-StateId 0,
  ...
  candidate-tci-StateId 1,
  ...
  candidate-tci-StateId 2,
  ...
}
```

### Periodic CSI-RS

In some implementations, the TCI state of the periodic CSI-RS may be configured by the RRC signaling. In addition, the RRC signaling may be used to configure the candidate TCI states in the TCI framework #3.

In some implementations, the network may use the L1/L2 signaling (e.g., a MAC CE or a DCI format) to further indicate the candidate TCI states in the TCI framework #3.

FIG. 12 is a diagram illustrating a MAC CE 1200 for indicating a TCI state after the NES adaptation in the TCI framework #3, according to an example implementation of the present disclosure. The MAC CE 1200 may include a field candidate-tci-State-Id (e.g., in octet 2) for indicating the candidate TCI state in the TCI framework #3.

In some implementations, a DCI format may include a field Candidate TCI State ID for indicating a specific TCI state after the NES adaptation from the candidates pre-configured in the TCI framework #3. In some implementations, the field Candidate TCI State ID in the DCI format may include an index. For example, index 0 may correspond to candidate TCI state ID 0, index 1 may correspond to candidate TCI state ID 1, and so on.

### Semi-Persistent CSI-RS

The TCI state of the semi-persistent CSI-RS may be configured in the tci-StatesToAddModList in the PDSCH-Config. In some implementations, the network may reuse the MAC CE 400 in FIG. 4 to further indicate a candidate TCI state of each resource in the resource set for the TCI framework #3.

### Aperiodic CSI-RS

In some implementations, the TCI state of the aperiodic CSI-RS may be configured via the RRC signaling (e.g., in the CSI-AssociatedReportConfigInfo as shown in Table 6 above). In addition, the RRC signaling may be used to configure and indicate the candidate TCI state in the TCI framework #3.

### PDCCH DMRS

In some implementations, the network may use a new list tci-CandidateStatesPDCCH-ToAddList to configure a list of candidate TCI states for the PDCCH DMRS QCL relation in the TCI framework #3. The tci-CandidateStatesPDCCH-ToAddList may be a subset of the TCI states defined in the pdsch-Config included in the BWP-DownlinkDedicated corresponding to the serving cell and the DL BWP to which the ControlResourceSet belongs.

The TCI state of the PDCCH DMRS may be configured in the tci-StatesPDCCH-ToAddList tci-CandidateStatesPDCCH-ToAddList defined in the pdsch-Config. In some implementations, the network may use the MAC CE 600 in FIG. 6 to further indicate the candidate TCI state of the PDCCH DMRS.

### PDSCH DMRS

In some implementations, the network may use the MAC CE 800 in FIG. 8 to activate/deactivate the candidate TCI states for the PDSCH DMRS QCL relation in the TCI framework #3. In some implementations, the codepoint relationship of the DCI TCI field may be reused to indicate the candidate TCI states in the TCI framework #3.

### R15 Unified TCI Update of NES Adaptation

There may be a new unified L1/L2 signaling approach/mechanism to update the R15 TCI states of multiple resources to reduce the signaling overhead. The multiple resources may include periodic CSI-RS resources, semi-persistent CSI-RS resources, aperiodic CSI-RS resources, PDCCH DMRS, and PDSCH DMRS.

For the periodic CSI-RS, the semi-persistent CSI-RS, the aperiodic CSI-RS, the PDCCH DMRS, and the PDSCH DMRS, updated QCL information, due to the NES adaptation, may be configured and indicated consistently. There may be a unified L1/L2 signaling approach. There may be a pre-configured table describing the relation between each kind of reference signal and the type of port adaptation. In some implementations, the network may use a port subset indication to describe the port reduction.

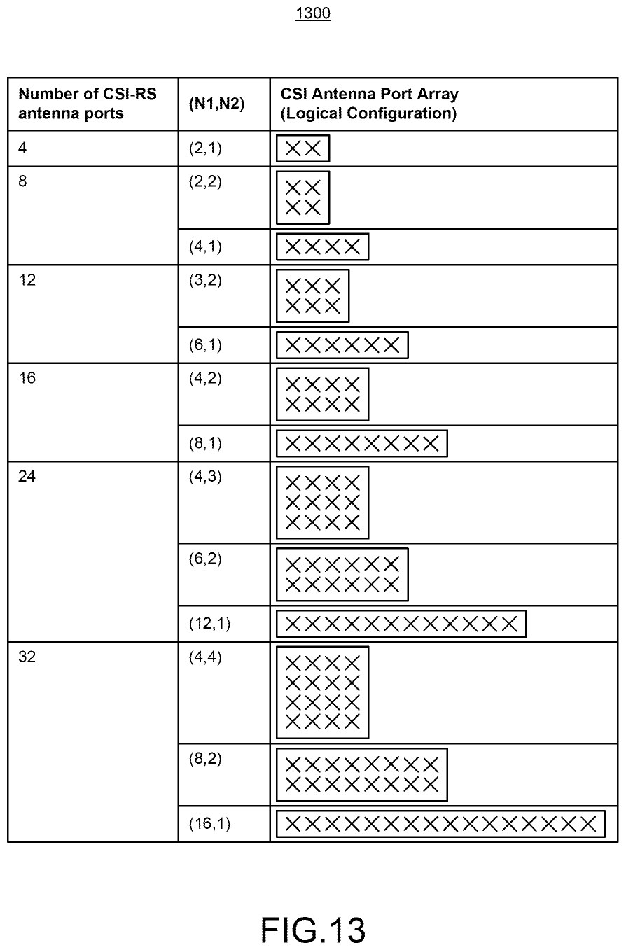

A spatial pattern may be defined as a possible layout of a CSI antenna port array or a subset of antenna ports. A spatial pattern may be associated with a number of CSI-RS antenna ports and a pair of (N₁, N₂), where N₁ is the number of antenna elements in the first dimension and N₂ is the number of antenna elements in the second dimension. FIG. 13 is a diagram 1300 illustrating a table listing the association between a pair of (N₁, N₂) and a layout of CSI antenna port array, according to an example implementation of the present disclosure. Each row in the table that corresponds to a CSI antenna port array may represent a spatial pattern.

Table 10 below illustrates antenna ports defined for various channels or signals, according to an example implementation of the present disclosure.

TABLE 10

| Channel/Signal | Antenna Ports |
|---|---|
| PDSCH | Antenna ports starting with 1000 |
| PDCCH | Antenna ports starting with 2000 |
| CSI-RS | Antenna ports starting with 3000 |
| SS/PBCH | Antenna ports starting with 4000 |
| PUSCH/DMRS | Antenna ports starting with 0 |
| SRS | Antenna ports starting with 1000 |
| PUCCH | Antenna ports starting with 2000 |
| PRACH | Antenna port 4000 |

In some implementations, the network may predefine the relationship between the TCI states and the antenna ports by utilizing one or more indices to indicate the adaptation. Table 11 below illustrates an example table for indicating TCI states for reference signals under Type-1 adaptation, according to an example implementation of the present disclosure. In some implementations, the table for indicating the TCI states for the reference signals (e.g., Table 11) may be configured via the RRC signaling before the NES adaptation.

TABLE 11

| | | Semi- | | | |
|---|---|---|---|---|---|
| | Periodic | Persistent | Aperiodic | PDCCH | PDSCH |
| | CSI-RS | CSI-RS | CSI-RS | DMRS | DMRS |
| Index 0 | Original | Original | Original | Single | Original |
| | TCI state | TCI state | TCI state | antenna port | TCI state |
| | | | | 2000 | |
| | | | | TCI state | |
| Index 1 | 32 ports | 32 ports | 32 ports | | 12 ports |
| | TCI state | TCI state | TCI state | | TCI state |
| Index 2 | 16 ports-1 | 16 ports-1 | 16 ports-1 | | 10 ports |
| | TCI state | TCI state | TCI state | | TCI state |
| Index 3 | 16 ports-2 | 16 ports-2 | 16 ports-2 | | 8 ports |
| | TCI state | TCI state | TCI state | | TCI state |
| Index 4 | 8 ports-1 | 8 ports-1 | 8 ports-1 | | 4 ports |
| | TCI state | TCI state | TCI state | | TCI state |
| Index 5 | 8 ports-2 | 8 ports-2 | 8 ports-2 | | 2 ports |
| | TCI state | TCI state | TCI state | | TCI state |

The index 0 may indicate the original TCI state of each reference signal. The index 1 may indicate the TCI state of the reference signal after the first type of NES adaptation. The index 2 may indicate that the TCI state of the reference signal after the second type of NES adaptation. For example, for the aperiodic CSI-RS, changing the index from 1 to 2 may correspond to changing the antenna ports from 32 ports (4,4), as shown in FIG. 13, to 16 ports-1 (4,2), as shown in FIG. 13.

The index 3 may indicate the TCI state of the reference signal after the third type of NES adaptation. For example, for the aperiodic CSI-RS, changing the index from 1 to 3 may correspond to changing the antenna ports from 32 ports (8,2) in FIG. 13 to 16 ports-2 (8,1) in FIG. 13.

The index 2 may also indicate the TCI state of the PDSCH DMRS after the NES adaptation. For example, for the PDSCH DMRS, changing the index from 1 to 3 may correspond to changing the antenna ports from the 12 ports to 10 ports.

In some implementations, even if the adaptation is without a reduction in the number of antenna ports (which may be referred to as the Type-2 adaptation in the present disclosure), the network may also predefine the relationship between the TCI state and the antenna ports with different power values. Table 12 below illustrates an example table for indicating the TCI states for the reference signals under Type-2 adaptation, according to an example implementation of the present disclosure. In some implementations, the table for indicating the TCI states for the reference signals (e.g., Table 12) may be configured via the RRC signaling before the NES adaptation. The parameters P1, P2, P3, P4 in Table 12 may correspond to different power values.

TABLE 12

| | | Semi- | | | |
|---|---|---|---|---|---|
| | Periodic | Persistent | Aperiodic | PDCCH | PDSCH |
| | CSI-RS | CSI-RS | CSI-RS | DMRS | DMRS |
| Index 0 | Original | Original | Original | Single | Original |
| | TCI state | TCI state | TCI state | antenna | TCI state |
| | | | | port 2000 | |
| | | | | TCI state | |
| Index 1 | 32 ports | 32 ports | 32 ports | | 12 ports |
| | TCI state | TCI state | TCI state | | TCI state |
| Index 2 | 16 ports-P1 | 16 ports-P1 | 16 ports-P1 | | 10 ports |
| | TCI state | TCI state | TCI state | | TCI state |
| Index 3 | 16 ports-P2 | 16 ports-P2 | 16 ports-P2 | | 8 ports |
| | TCI state | TCI state | TCI state | | TCI state |
| Index 4 | 16 ports-P3 | 16 ports-P3 | 16 ports-P3 | | 4 ports |
| | TCI state | TCI state | TCI state | | TCI state |
| Index 5 | 16 ports-P4 | 16 ports-P4 | 16 ports-P4 | | 2 ports |
| | TCI state | TCI state | TCI state | | TCI state |

For example, for the aperiodic CSI-RS, the index 2 may correspond to a TCI state with 16 ports and a first power offset value P1. For the aperiodic CSI-RS, the index 3 may be correspond to a TCI state with 16 ports and a second power offset value P2.

In some implementations, the network may pre-configure a combined table that is a combination of Table 11, for the Type-1 adaptation, and Table 12, for the Type-2 adaptation. For example, a portion of the combined table may be derived from Table 11 and the other portion of the combined table may be derived from Table 12.

After the network pre-configures the table (e.g., Table 11, Table 12, or a combination thereof), the network may utilize the L1/L2 signaling to indicate the TCI state after the NES adaptation.

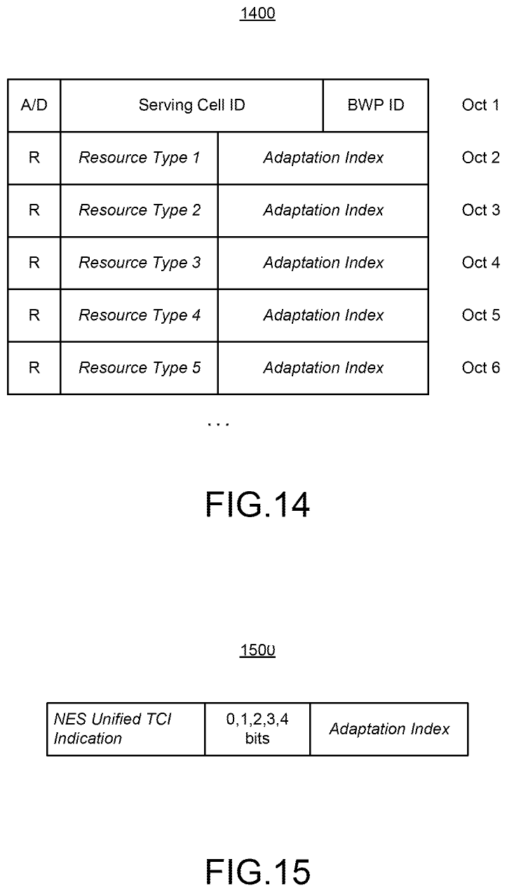

In some implementations, the network may use a new MAC CE format to indicate the TCI change of the adaptation. FIG. 14 is a diagram illustrating a MAC CE 1400 for indicating a TCI change, according to an example implementation of the present disclosure. In the MAC CE 1400, a new field Resource Type may be configured by the network to indicate which resource's the TCI state may need to be updated. For example, the Resource Type 1 may be configured, as the first resource in Table 11 or Table 12, which is a periodic CSI-RS, the Resource Type 2 may be configured, as the second resource in Table 11 or Table 12, which is a semi-persistent CSI-RS, and so on. The field Adaptation Index may be configured, as an index value in Table 11 or Table 12, which may range from index 0 to index 5. The MAC CE 1400 may also be referred to as a unified TCI change MAC CE. The network may utilize the MAC CE 1400 to inform the UE of the TCI change/update/adaptation of multiple resources.

For the L1 signaling, the network may use a new DCI format or may reuse an existing DCI format 0_1 to indicate the NES adaptation. In some implementations, there may be a new field (e.g., the field NES unified TCI indication) in the DCI format (e.g., the DCI format 0_1) to implicitly indicate to the UE an adaptation index for multiple pre-configured resources (e.g., in Table 11 or Table 12). FIG. 15 is a diagram illustrating a DCI format 1500 for providing an NES unified TCI indication, according to an example implementation of the present disclosure.

In some implementations, the network may use the new field NES Unified TCI indication to provide a unified signal to the UE regarding the TCI changes for multiple resources. For example, the DCI format 1500 may indicate to the UE that multiple resources have a NES adaption from index 1 to index 3 (e.g., in Table 11 or Table 12). For example, the periodic CSI-RS may have a NES adaptation from index 1 (e.g., 32 ports) to index 3 (e.g., 16 ports-1). The semi-persistent CSI-RS may also have a NES adaptation from index 1 (e.g., 32 ports) to index 3 (e.g., 16 ports-2). The aperiodic CSI-RS may also have a NES adaptation from index 1 (e.g., 32 ports) to index 3 (e.g., 16 ports-2). According to Table 12, the index 2 may indicate that the resource is with 16 ports and the first power offset P1, and the index 3 may indicate that the resource is with 16 ports and the second power offset P2.

### R17 L1/L2 Signaling for Each Framework

Having different beam indication/update mechanisms of the R15/R16 framework may increase the complexity, overhead, and latency of the beam management. Such drawbacks may be troublesome for high mobility scenarios requiring a large number of configured TCI states. In these challenging scenarios, inefficiencies may lead to not only loss of throughput, but also loss of connections. In the 3GPP R17, a streamlined beam management framework for multi-beam operations and procedures, that are common for data and control, and UL and DL channels, has been provided. This framework may be referred to, as the unified TCI framework, which was first introduced in the 3GPP R17 for the single TRP operation. In the present disclosure, the TCI change/update of the NES adaptation may also be applied to the R17 unified TCI framework.

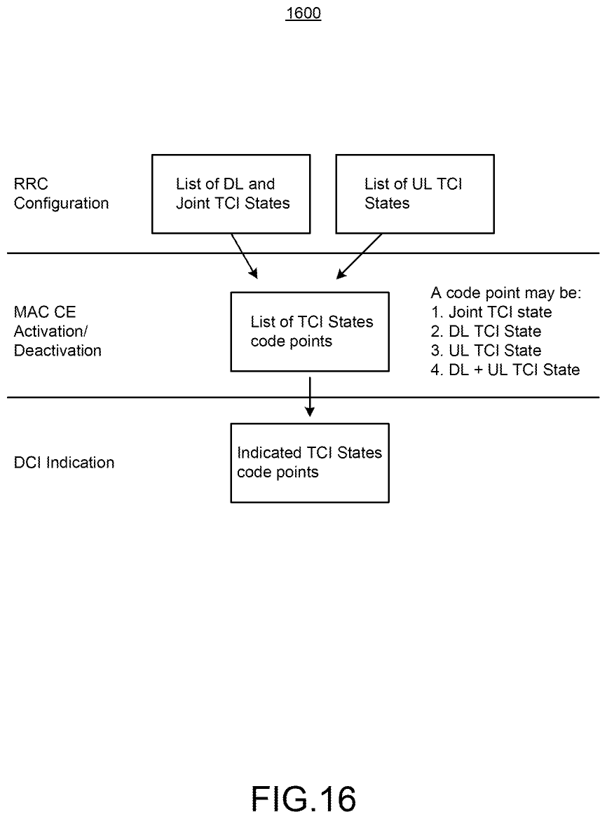

FIG. 16 is a diagram 1600 illustrating a unified TCI framework, according to an example implementation of the present disclosure. The network may transmit a configuration, including two lists of TCI states, via the RRC signaling. The first list of TCI states may be used for DL and joint TCI states (or DL and joint beam indication). Each TCI state may include a TCI state ID and two QCL fields, where each QCL field may indicate a QCL Type and a source reference signal. For example, the first list of TCI states may include a first TCI state that includes a first QCL field and a second QCL field, indicating a first QCL type and a second QCL type, respectively. In some implementations, the first QCL type may be different from the second QCL type.

The second list of TCI states may be used for UL TCI states (or UL beam indication). Each TCI state may include a TCI state ID and two QCL fields, where each QCL field may indicate a QCL Type and a source reference signal. For the UL TCI states, the source reference signal (or uplink spatial relation reference signal) may be a DL reference signal (e.g., the SSB or CSI-RS) or a UL reference signal (e.g., the SRS).

As shown in FIG. 16, the network may activate up to 16 TCI state code points via a MAC CE. A TCI state code point may be a joint TCI state, a DL TCI state, a UL TCI state, or a pair of a DL TCI state and a UL TCI state. The network may use a TCI field in a downlink-related DCI format (e.g., the DCI format 1_1 or DCI format 1_2) to inform the UE of a TCI state code point. For example, the DCI format may indicate a TCI state among the TCI states activated by the MAC CE. The DCI format may or may not include a DL assignment. The DCI format without the DL assignment may be used specifically for beam indication. In some implementations, if the MAC CE activates a single TCI state code point, the UE may apply the activated TCI state code point after the MAC CE processing latency without any further DCI signaling. For the NES adaptation, the unified TCI framework may be expanded as follows:

### L1/L2 Signaling in the TCI Framework #1

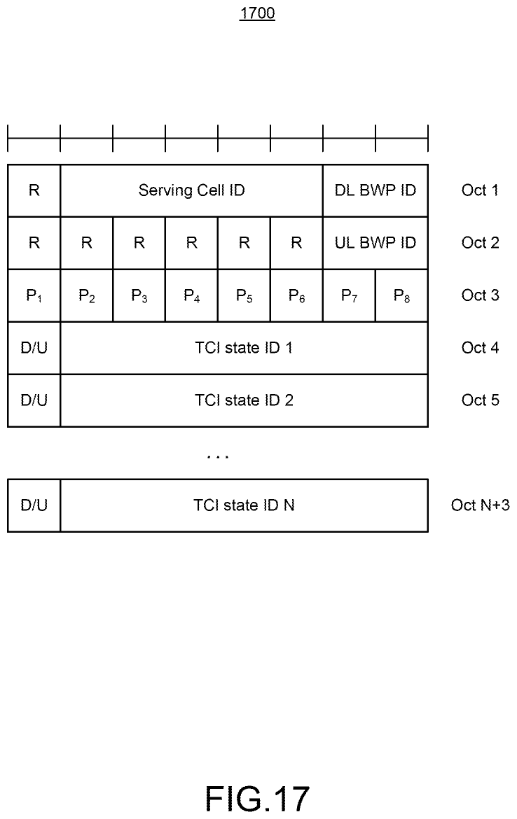

FIG. 17 is a diagram illustrating a MAC CE 1700 for the unified TCI state activation/deactivation, according to an example implementation of the present disclosure. The field TCI state ID (e.g., in each octet starting from octet 4) may activate a TCI state and may be referred to as a MAC CE activation field.

For the TCI framework #1 in the unified TCI framework, there may be additional indication(s) in the TCI state, as shown in Table 2 above, such as the pattern sub-configuration ID. In some implementations, the MAC CE activation field may be expanded to more than 16 TCI states due to the pattern ID or sub-configuration ID in the TCI framework #1.

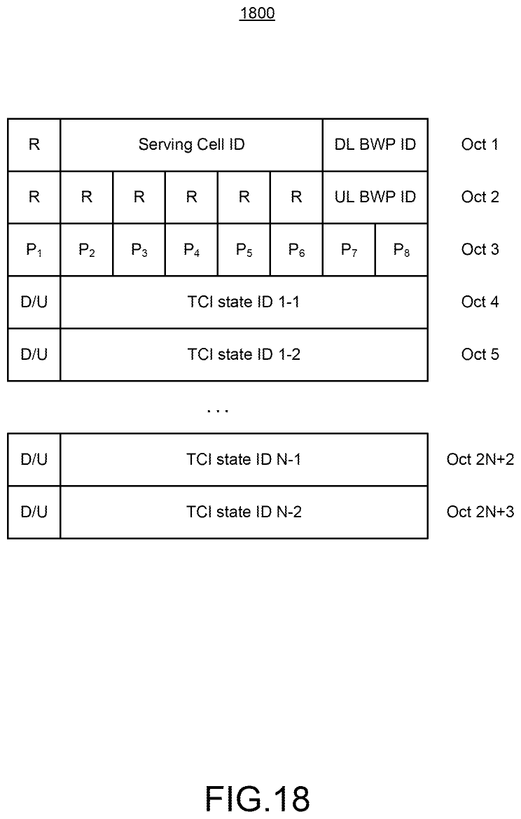

FIG. 18 is a diagram illustrating a MAC CE 1800 for the TCI state activation/deactivation in the TCI framework #1, according to an example implementation of the present disclosure. In some implementations, the TCI state ID 1-1, as shown in FIG. 18, may correspond to the TCI state ID 1, as shown in FIG. 17, with the pattern ID 1 or sub-configuration ID 1. Similarly, the TCI state ID 1-2, as shown in FIG. 18, may correspond to the TCI state ID 1, as shown in FIG. 17, with the pattern ID 2 or sub-configuration ID 2, and so on. In some implementations, the network may configure more than 16 TCI states to further expand the possible TCI state change, as the NES adaptation. The network may inform the UE of the TCI state code point via a TCI field in a downlink-related DCI format (e.g., the DCI format 1_1 or DCI format 1_2).

In some implementations, the network may utilize the MAC CE 1700, as shown in FIG. 17, to configure the possible TCI states of the NES adaptation. The network may utilize a downlink-related DCI format with a new field to indicate to the UE the pattern ID or sub-configuration ID in the TCI framework #1. The UE may update the TCI states stored in the UE based on the pattern ID or sub-configuration ID in the DCI format.

### L1/L2 Signaling in the TCI Framework #2

In some implementations, the network may utilize the MAC CE 1700, as shown in FIG. 17, to configure the possible TCI states of the NES adaptation. The network may utilize a downlink-related DCI format with a new field to indicate to the UE the candidate reference signal in the TCI framework #2. The UE may update the TCI states stored in the UE based on candidate reference signal indicated in the DCI format.

In some implementations, the network may utilize the MAC CE 1700, as shown in FIG. 17, to configure the possible TCI states of the NES adaptation. The network may utilize a downlink-related DCI format with a first field and a second field. The first field may indicate the candidate reference signal in the TCI framework #2. The second field may indicate the QCL type in the TCI framework #2. The UE may update the TCI states stored in the UE based on the DCI format.

### L1/L2 Signaling in the TCI Framework #3

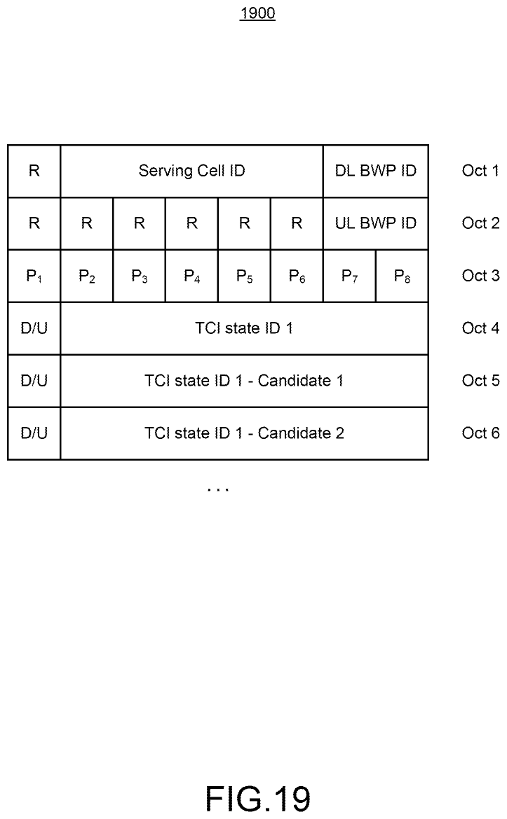

FIG. 19 is a diagram illustrating a MAC CE 1900 for the TCI state activation/deactivation in the TCI framework #3, according to an example implementation of the present disclosure. In some implementations, the TCI state ID 1, as shown in FIG. 19, may correspond to the TCI state ID 1, as shown in FIG. 17, the TCI state ID 1-Candidate 1, as shown in FIG. 19, may correspond to the first candidate TCI state of the TCI state ID 1, as shown in FIG. 17, the TCI state ID 1-Candidate 2, as shown in FIG. 19, may correspond to the second candidate TCI state of the TCI state ID 1, as shown in FIG. 17, and so on. In some implementations, the network may configure more than 16 TCI states to further expand the possible TCI state change, as the NES adaptation. The network may inform the UE of the TCI state code point via a TCI field in a downlink-related DCI format (e.g., the DCI format 1_1 or DCI format 1_2).

### Fast Adaptation of NES on TCI State Update

The network may require a number of TCI state changes in a cell for the Type-1/Type-2 spatial adaptation. Implementations disclosed in the present disclosure may reduce the above signaling overhead.

The NES adaptation of antenna ports/antenna elements may be common to the UEs that operate in a serving cell. A method for updating the TCI states that is dedicated to a specific UE may not be efficient or applicable to the fast NES adaptation. In some implementations, there may be a common L1/L2 signaling to inform the UEs operating in the serving cell of the TCI state update. The network may support a group-cast PDCCH to indicate the TCI state update, as the NES adaptation. In some implementations, the network may use the System Information (SI) to broadcast the TCI update information to the UEs operating in the cell.

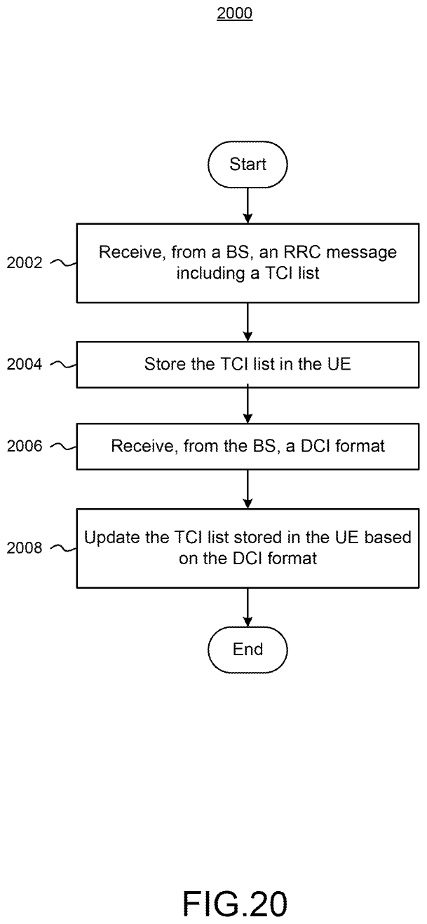

FIG. 20 is a flowchart illustrating a method/process 2000 performed by a UE for NES, according to an example implementation of the present disclosure. In the action 2002, the process 2000 may start by receiving, from a BS, an RRC message including a TCI list. In the action 2004, the process 2000 may store the TCI list in the UE. In the action 2006, the process 2000 may receive, from the BS, a DCI format. In the action 2008, the process 2000 may update the TCI list stored in the UE based on the DCI format. The process 2000 may then end.

The steps/actions shown in FIG. 1 should not be construed as necessarily order dependent. The order in which the process is described is not intended to be construed as a limitation. Moreover, some of the actions shown in FIG. 1 may be omitted in some implementations and one or more actions shown in FIG. 1 may be combined.

The technical problem addressed by the method illustrated in FIG. 1 is how to achieve efficient network energy saving. By receiving a TCI list and updating the TCI list based on the DCI format, the UE may dynamically adjust its transmission configuration. This adaptability may help in optimizing the energy consumption of the network. In addition, the ability to update the TCI list based on the DCI format may ensure that the UE maintains the synchronization with the BS regarding the transmission configurations, which may enhance the reliability and the quality of the communication link.

In some implementations, the TCI list may include a first TCI state that includes a first QCL field, and the first QCL field may indicate a first reference signal and a first QCL type. Examples of the data structures of a TCI state may be seen in Table 1, Table 2, and Table 3, as described above.

In some implementations, the first QCL field may further indicate at least one spatial pattern associated with the first reference signal. As shown in Table 2, the first QCL field may correspond to the qcl-Type1, which may indicate the first reference signal referenceSignal csi-rs: k. The first QCL field may also indicate multiple pattern IDs, or sub-configuration IDs, that are associated with the first reference signal, such as the pattern sub-configuration ID 1, the pattern sub-configuration ID 2, and so on.

In some implementations, the DCI format may include a first index associated with a particular one of the at least one spatial pattern indicated by the first QCL field. The UE may update the TCI list stored in the UE by selecting the particular one of the at least one spatial pattern to be applied on the first reference signal based on the first index. For example, the first index included in the DCI format may correspond to the pattern sub-configuration ID 2. After receiving the DCI format, the UE may update the TCI list by selecting the pattern sub-configuration ID 2 as the pattern to be applied on the first reference signal.

In some implementations, the first QCL field may further indicate at least one candidate reference signal. As shown in Table 3, the first QCL field may correspond to the qcl-Type1, which may indicate multiple candidate reference signals, including the candidate referenceSignal csi-rs k′ and the candidate referenceSignal csi-rs k″.

In some implementations, the DCI format may include a first index associated with a particular one of the at least one candidate reference signal indicated by the first QCL field. The UE may update the TCI list stored in the UE by determining that the first QCL type is associated with the particular one of the at least one candidate reference signal based on the first index. For example, the first index included in the DCI format may correspond to the candidate referenceSignal csi-rs k′. After receiving the DCI format, the UE may update the TCI list by determining that the first QCL type is associated with the candidate referenceSignal csi-rs k′.

In some implementations, the first TCI state may further include a second QCL field. The second QCL field may indicate a second reference signal and a second QCL type. The first QCL type may be different from the second QCL type. As shown in Table 2 or Table 3, the first QCL field and the second QCL field may correspond to the qcl-Type1 and the qcl-Type2, respectively. The first QCL type indicated by the qcl-Type1 may be TypeA. The second QCL type indicated by the qcl-Type2 may be TypeD, which is different from the first QCL type.

In some implementations, the first reference signal may include a CSI-RS. As shown in Table 2 or Table 3, the first reference signal indicated by the first QCL field (e.g., the qcl-Type1) may be a CSI-RS, and the second reference signal indicated by the second QCL field (e.g., the qcl-Type2) may also be the CSI-RS.

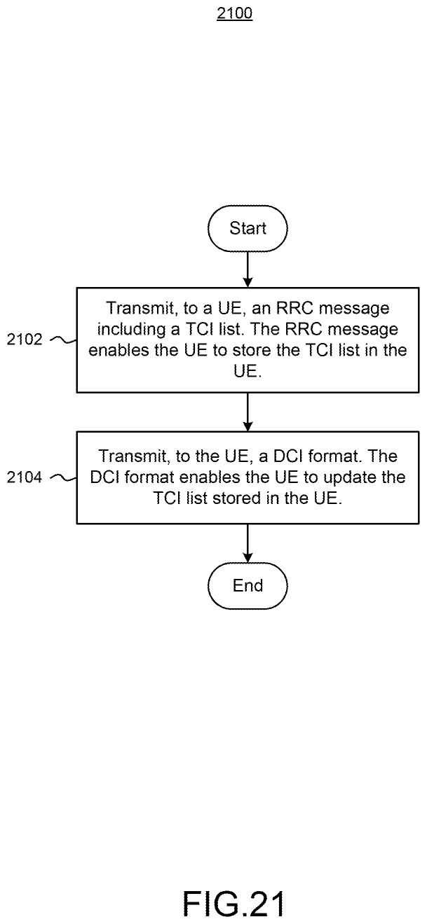

FIG. 21 is a flowchart illustrating a method/process 2100 performed by a BS for NES, according to an example implementation of the present disclosure. In the action 2102, the process 2100 may start by transmitting, to a UE, an RRC message including a TCI list. The RRC message may enable the UE to store the TCI list in the UE. In the action 2104, the process 2100 may transmit, to the UE, a DCI format. The DCI format may enable the UE to update the TCI list stored in the UE. The process 2100 may then end. The method illustrated in FIG. 2100 is similar to that in FIG. 2000, except that it is described from the perspective of the BS (instead of the UE).

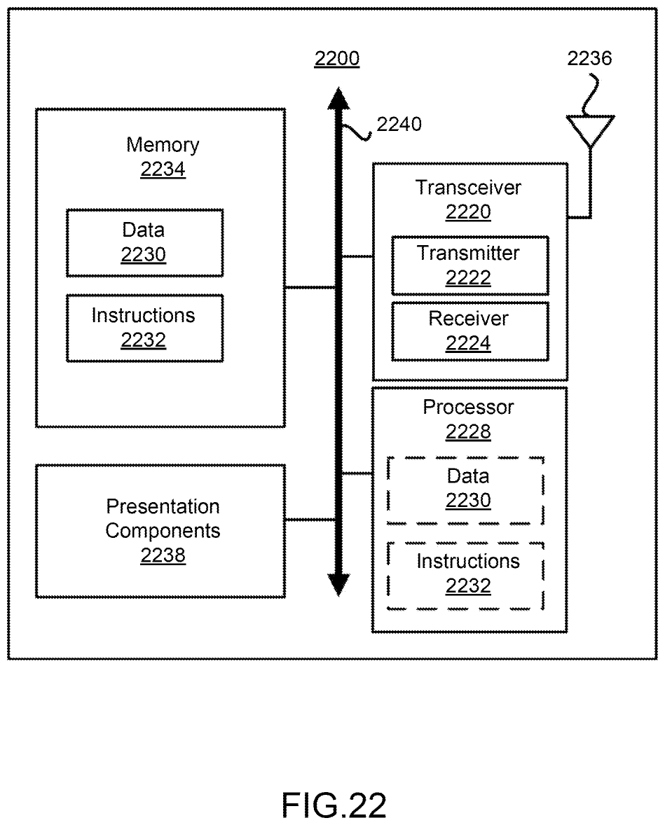

FIG. 22 is a block diagram illustrating a node 2200 for wireless communication in accordance with various aspects of the present disclosure. As illustrated in FIG. 22, a node 2200 may include a transceiver 2220, a processor 2228, a memory 2234, one or more presentation components 2238, and at least one antenna 2236. The node 2200 may also include a radio frequency (RF) spectrum band module, a BS communications module, a network communications module, and a system communications management module, Input/Output (I/O) ports, I/O components, and a power supply (not illustrated in FIG. 22).

Each of the components may directly or indirectly communicate with each other over one or more buses 2240. The node 2200 may be a UE or a BS that performs various functions disclosed with reference to FIGS. 1 through 21.

The transceiver 2220 has a transmitter 2222 (e.g., transmitting/transmission circuitry) and a receiver 2224 (e.g., receiving/reception circuitry) and may be configured to transmit and/or receive time and/or frequency resource partitioning information. The transceiver 2220 may be configured to transmit in different types of subframes and slots including, but not limited to, usable, non-usable, and flexibly usable subframes and slot formats. The transceiver 2220 may be configured to receive data and control channels.

The node 2200 may include a variety of computer-readable media. Computer-readable media may be any available media that may be accessed by the node 2200 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the above listed components should also be included within the scope of computer-readable media.

The memory 2234 may include computer-storage media in the form of volatile and/or non-volatile memory. The memory 2234 may be removable, non-removable, or a combination thereof. Example memory may include solid-state memory, hard drives, optical-disc drives, etc. As illustrated in FIG. 22, the memory 2234 may store a computer-readable and/or computer-executable instructions 2232 (e.g., software codes) that are configured to, when executed, cause the processor 2228 to perform various functions disclosed herein, for example, with reference to FIGS. 1 through 21. Alternatively, the instructions 2232 may not be directly executable by the processor 2228 but may be configured to cause the node 2200 (e.g., when compiled and executed) to perform various functions disclosed herein.

The processor 2228 (e.g., having processing circuitry) may include an intelligent hardware device, e.g., a Central Processing Unit (CPU), a microcontroller, an ASIC, etc. The processor 2228 may include memory. The processor 2228 may process the data 2230 and the instructions 2232 received from the memory 2234, and information transmitted and received via the transceiver 2220, the baseband communications module, and/or the network communications module. The processor 2228 may also process information to send to the transceiver 2220 for transmission via the antenna 2236 to the network communications module for transmission to a CN.

One or more presentation components 2238 may present data indications to a person or another device. Examples of presentation components 2238 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a User Equipment (UE) for Network Energy Saving (NES), the method comprising:
receiving, from a Base Station (BS), a Radio Resource Control (RRC) message comprising a Transmission Configuration Indication (TCI) list;
storing the TCI list in the UE;
receiving, from the BS, a Downlink Control Information (DCI) format; and
updating the TCI list stored in the UE based on the DCI format.

2. The method of claim 1, wherein:
the TCI list comprises a first TCI state that includes a first Quasi Co-Location (QCL) field, and
the first QCL field indicates a first reference signal and a first QCL type.

3. The method of claim 2, wherein:
the first QCL field further indicates at least one spatial pattern associated with the first reference signal.

4. The method of claim 3, wherein:
the DCI format includes a first index associated with one of the at least one spatial pattern indicated by the first QCL field, and
updating the TCI list stored in the UE comprises selecting the one of the at least one spatial pattern to be applied on the first reference signal based on the first index.

5. The method of claim 2, wherein:
the first QCL field further indicates at least one candidate reference signal.

6. The method of claim 5, wherein:
the DCI format includes a first index associated with one of the at least one candidate reference signal indicated by the first QCL field, and
updating the TCI list stored in the UE comprises determining that the first QCL type is associated with the one of the at least one candidate reference signal based on the first index.

7. The method of claim 2, wherein:
the first TCI state further includes a second QCL field,
the second QCL field indicates a second reference signal and a second QCL type, and
the first QCL type is different from the second QCL type.

8. The method of claim 2, wherein:
the first reference signal comprises a Channel State Information-Reference Signal (CSI-RS).

9. A User Equipment (UE) for Network Energy Saving (NES), the UE comprising:
at least one processor; and
at least one non-transitory computer-readable medium coupled to the at least one processor and storing one or more computer-executable instructions that, when executed by the at least one processor, cause the UE to:
receive, from a Base Station (BS), a Radio Resource Control (RRC) message comprising a Transmission Configuration Indication (TCI) list;
store the TCI list in the UE;
receive, from the BS, a Downlink Control Information (DCI) format; and
update the TCI list stored in the UE based on the DCI format.

10. The UE of claim 9, wherein:
the TCI list comprises a first TCI state that includes a first Quasi Co-Location (QCL) field, and
the first QCL field indicates a first reference signal and a first QCL type.

11. The UE of claim 10, wherein:
the first QCL field further indicates at least one spatial pattern associated with the first reference signal.

12. The UE of claim 11, wherein:
the DCI format includes a first index associated with one of the at least one spatial pattern indicated by the first QCL field, and
updating the TCI list stored in the UE comprises selecting the one of the at least one spatial pattern to be applied on the first reference signal based on the first index.

13. The UE of claim 10, wherein:
the first QCL field further indicates at least one candidate reference signal.

14. The UE of claim 13, wherein:
the DCI format includes a first index associated with one of the at least one candidate reference signal indicated by the first QCL field, and
updating the TCI list stored in the UE comprises determining that the first QCL type is associated with the one of the at least one candidate reference signal based on the first index.

15. The UE of claim 10, wherein:
the first TCI state further includes a second QCL field,
the second QCL field indicates a second reference signal and a second QCL type, and
the first QCL type is different from the second QCL type.

16. The UE of claim 10, wherein:
the first reference signal comprises a Channel State Information-Reference Signal (CSI-RS).

17. A Base Station (BS) for Network Energy Saving (NES), the BS comprising:
at least one processor; and
at least one non-transitory computer-readable medium coupled to the at least one processor and storing one or more computer-executable instructions that, when executed by the at least one processor, cause the BS to:
transmit, to a User Equipment (UE), a Radio Resource Control (RRC) message comprising a Transmission Configuration Indication (TCI) list, the RRC message enabling the UE to store the TCI list in the UE; and
transmit, to the UE, a Downlink Control Information (DCI) format, the DCI format enabling the UE to update the TCI list stored in the UE.

18. The BS of claim 17, wherein:
the TCI list comprises a first TCI state that includes a first Quasi Co-Location (QCL) field, and
the first QCL field indicates a first reference signal and a first QCL type.

19. The BS of claim 18, wherein:
the first QCL field further indicates at least one spatial pattern associated with the first reference signal,
the DCI format includes a first index associated with one of the at least one spatial pattern indicated by the first QCL field, and
the UE updates the TCI list stored in the UE by selecting the one of the at least one spatial pattern to be applied on the first reference signal based on the first index.

20. The BS of claim 18, wherein:
the first QCL field further indicates at least one candidate reference signal,
the DCI format includes a first index associated with one of the at least one candidate reference signal indicated by the first QCL field, and
the UE updates the TCI list stored in the UE by determining that the first QCL type is associated with the one of the at least one candidate reference signal based on the first index.
